(19) United States
(12) Patent Application Publication
(10) Pub. No.: US 2026/0341624 A1
(43) Pub. Date: Oct. 29, 2026

(54) APPARATUS FOR ELECTRON FLOW CONTROL

(71) Applicant: X-Sight Incorporated, Cambridge, MA (US)

(72) Inventors: Winston Chern, Cambridge, MA (US); Andrew Yu, Somerville, MA (US)

(21) Appl. No.: 19/364,574

(22) Filed: Oct. 21, 2025

Related U.S. Application Data
(60) Provisional application No. 63/796,113, filed on Apr. 28, 2025.

(51) Int. Cl. H01J 3/02

(52) U.S. Cl. CPC H01J 3/021; H01J 2203/0224; H01J 2203/0252; H01J 2203/0292

(57) ABSTRACT

An apparatus for controlling electron flow includes: a cathode comprising: a package substrate; at least one electron source mounted on the package substrate, the electron source comprising a plurality of field emitter array tiles and a common gate electrode disposed above the field emitter array tiles, the common gate electrode having openings aligned with emitter tips in the field emitter array tiles to allow passage of emitted electrons; and a focusing element disposed above the at least one electron source, the focusing element comprising a conductive structure with through-apertures aligned with each electron source to shape an electron beam emitted by the field emitter array tiles; and one or more anodes comprising a metal target distant from the focusing element.

### CROSS-REFERENCE TO RELATED APPLICATION/CLAIM OF PRIORITY

This application claims the benefit of, and priority to U.S. Application No. 63/796,113, filed on Apr. 28, 2025, the entire contents of which are hereby incorporated herein by reference.

### TECHNICAL FIELD

The present disclosure relates to an apparatus comprising one or more field emitter array electron sources for use in multiple system types including electron tubes, x-ray sources, ionizers, mass spectrometers, and high voltage switches.

### BACKGROUND

Conventional electron sources for x-ray tubes, electron beam instruments, and other vacuum electronic devices often rely on thermionic cathodes that emit electrons by heating a filament or dispenser material to very high temperatures. These approaches consume significant power, require bulky heating and cooling infrastructure, and can suffer from slow modulation speeds and short operational lifetimes due to thermal degradation. Field emitter array cathodes have emerged as promising alternatives because they can generate electron emission at or near room temperature without continuous heating. Such cold cathodes enable faster switching, lower power consumption, and improved integration with modern electronics. However, existing field emitter array designs face challenges including limited emission control, difficulty producing complex focal spot patterns, and insufficient packaging integration with control circuitry and focusing elements.

### SUMMARY

In accordance with aspects of the disclosure, an apparatus for controlling electron flow includes a cathode comprising a package substrate and at least one electron source mounted on the package substrate. The electron source includes a plurality of field emitter array tiles and a common gate electrode disposed above the tiles, the common gate electrode having openings aligned with emitter tips in the tiles to allow passage of emitted electrons. A focusing element is disposed above the at least one electron source, the focusing element comprising a conductive structure with through-apertures aligned with each electron source to shape an electron beam emitted by the field emitter array tiles. One or more anodes comprise a metal target distant from the focusing element. The common gate electrode of each electron source is held at a fixed bias voltage, and the field emitter array tiles of each electron source are electrically pulsed to generate one or more electron beams directed through the focusing element towards an anode.

In an aspect of the present disclosure, the apparatus may include control electronics configured to use external optical signals to programmatically turn individual field emitter array tiles on and off.

In an aspect of the present disclosure, the apparatus may be configured such that the electron sources output different focal spot shapes on an anode by selectively turning field emitter array tiles on and off.

In an aspect of the present disclosure, the field emitter array tiles in an electron source may output different currents to generate an arbitrary focal spot intensity pattern on an anode.

In an aspect of the present disclosure, an electron beam focusing element opening above an electron source may contain multiple disjoint openings with different sized areas.

In an aspect of the present disclosure, the electron beam focusing element openings above the electron sources may not all have the same geometry.

In an aspect of the present disclosure, two or more adjacent electron sources may have different geometries.

In an aspect of the present disclosure, different sized, disjoint groups of field emitter array tiles may be turned on at the same time within the same electron source to generate a focal spot pattern with different sized, disjoint focal spot regions.

In an aspect of the present disclosure, two or more electron sources may be turned on simultaneously with different subsets of field emitter array tiles turned on within each electron source to generate a focal spot pattern with different sized, disjoint focal spot regions.

In an aspect of the present disclosure, two or more electron sources may be configured with an electron beam focusing element shaped to steer the electron beam from each electron source to partially or fully overlap their focal spots on an anode.

In an aspect of the present disclosure, two or more electron sources may be oriented on the package substrate to steer their electron beams to partially or fully overlap their focal spots on an anode.

In an aspect of the present disclosure, two or more electron sources may be oriented such that the first electron source is configured to generate an x-ray fan beam, and the other electron sources are aligned so that one edge of their x-ray fan beam is aligned with an edge of the x-ray fan beam of the first electron source.

In an aspect of the present disclosure, an anode may be angled and two or more electron sources in the cathode may be offset along their in-plane positions so that their focal spots on an angled anode are offset along the anode angle.

In an aspect of the present disclosure, more than one anode may be configured at different bias voltages.

In accordance with aspects of the disclosure, an apparatus for controlling electron flow includes two or more cathodes, each cathode comprising a package substrate, at least one electron source mounted on the package substrate with a plurality of field emitter array tiles and a common gate electrode disposed above the tiles, and a focusing element disposed above the at least one electron source with through-apertures aligned with each electron source to shape an electron beam emitted by the tiles. One or more anodes comprise a metal target distant from the focusing element. Each cathode is configured with a different voltage ground potential relative to the one or more anodes, and the common gate electrode of each electron source is held at a fixed bias voltage while the field emitter array tiles are electrically pulsed to generate one or more electron beams directed through the focusing element towards an anode.

In an aspect of the present disclosure, one or more electron sources from each of the two or more cathodes configured at different potentials may be turned on and off sequentially in time.

In an aspect of the present disclosure, the focal spot generated from each cathode of the two or more cathodes may be unique.

In an aspect of the present disclosure, one or more electron sources from each of the two or more cathodes configured at different potentials may be operated simultaneously to generate disjoint, different sized focal spot regions on the anode with different energy spectrums for each focal spot region.

In an aspect of the present disclosure, two or more electron sources in the two or more cathodes configured at different potentials may be operated simultaneously with overlapping focal spots on an anode.

In an aspect of the present disclosure, two or more cathodes at different potentials may be physically oriented so their generated electron beam focal spots appear at about the same location on an anode.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 shows an exemplary schematic of an electron source comprising more than one field emitter array tiles and a common gate.

FIG. 2 shows an exemplary cross section schematic of the electron source in FIG. 1 further comprising tile electrical isolation and electrical contacts at the bottom.

FIG. 3 shows an exemplary schematic of the bottom-side layout of the electron source depicted in FIG. 2 showing the field emitter array tiles, gate contact regions, and electrical isolation.

FIG. 4 shows a block diagram schematic of two or more tiled field emitter array electron sources with a common gate, further integrated onto a cathode package with driver electronics for each field emitter array tile, controls, and peripheral electronics.

FIG. 5 shows an exemplary schematic showing multiple electron sources integrated on the same cathode package substrate with embedded electrical wiring, where the package substrate may include bonded control, driver, or other peripheral electronics.

FIG. 6 shows an exemplary schematic of electron sources comprising of multiple subunit field emitter array electron sources like FIG. 1 on a cathode package.

FIG. 7 shows an exemplary schematic of the electron sources and package substrate further comprising bonded electronics to each electron source, vacuum getter material, and resistive heater lines integrated on the package substrate.

FIG. 8 shows an exemplary schematic of a cathode package comprising integrated electron sources like FIG. 1, an electron beam focusing element, embedded electrical wiring, and an integrated vacuum getter material.

FIG. 9 shows an exemplary schematic of a cathode package comprising electron sources like FIG. 1, an electron beam focusing element offset using a raised package substrate layer, embedded electrical wiring, and an integrated vacuum getter material.

FIG. 10 shows a block diagram schematic of an apparatus for electron flow control comprising a field emitter array electron source cathode package with an electron beam focusing element and electronics, an anode, and external peripheral and control electronics.

FIG. 11 shows a block diagram schematic of an apparatus for electron flow control alternatively configured with the anode at ground potential and the cathode raised to a high negative potential.

FIG. 12 shows an exemplary schematic of an apparatus to control electron flow comprising a field emitter array electron source cathode, a shared metal electron beam focusing element, and a metal anode.

FIG. 13 shows an exemplary cross section schematic of an apparatus to control electron flow.

FIG. 14 shows an exemplary schematic of an apparatus to control electron flow operation configured with a tiled field emitter array electron source.

FIG. 15 shows an exemplary plot illustrating anode focal spot intensity profile along a spatial axis configured by the current emission profile from field emitter array tiles along the spatial axis.

FIG. 16 shows an exemplary schematic of a multi-modal electron beam focal spot on the anode comprising two or more disjoint focal spot regions of different sizes.

FIG. 17 shows an exemplary schematic of a side cut profile of an apparatus to control electron flow configured to generate a multi-modal focal spot using different sized electron sources or focusing element openings.

FIG. 18 shows an exemplary schematic of a side cut profile of an apparatus to control electron flow configured to generate a multi-modal focal spot using a tiled field emitter array electron source with certain emitter tiles turned on and off.

FIG. 19 shows an exemplary schematic of a side cut profile of an apparatus to control electron flow configured to generate a multi-modal focal spot using two or more field emitter array electron sources each configured with certain emitter tiles turned on and off.

FIG. 20 shows an exemplary schematic of two offset overlapping electron beam focal spots on the anode.

FIG. 21 shows an exemplary schematic of a side cut profile of an apparatus to control electron flow with a focusing element geometry configured to steer two or more electron source electron beams to generate overlapping focal spots on the anode.

FIG. 22 shows an exemplary schematic of a side cut profile of an apparatus to control electron flow with a package substrate configured to orient two or more electron sources to steer their electron beams to generate overlapping focal spots on the anode.

FIG. 23 shows an exemplary schematic of an apparatus to control electron flow configured with electron sources arranged with side sources aligned to a center source’s generated x-ray fan beam angle.

FIG. 24 shows an exemplary schematic of an apparatus to control electron flow anode with focal spot layout corresponding to an electron source layout like FIG. 23 and illustrating the central x-ray fan beam alignment with other sources and collimation.

FIG. 25 shows an exemplary schematic of the focal spots on the anode corresponding to an electron source configuration like FIG. 23 illustrating the x-ray fan beam generation and collimation.

FIG. 26 shows an exemplary side profile cross-section schematic of an apparatus to control electron flow configured with offset electron sources and an angled anode illustrating offset generated x-ray fan beam side profiles.

FIG. 27 shows a block diagram schematic of an apparatus to control electron flow configured with two cathodes at different voltage potentials relative to an anode and control and peripheral electronics.

FIG. 28 shows a block diagram schematic of an apparatus to control electron flow configured with two cathodes configured at different negative voltage potentials relative to a grounded anode.

FIG. 29 shows an exemplary schematic of a side cut profile of an apparatus to control electron flow comprising two cathodes at different voltage potentials relative to an anode.

FIG. 30 shows an exemplary schematic of a side cut profile of an apparatus to control electron flow comprising two cathodes at different voltage potentials relative to an anode, where the cathodes are positioned at different heights and with different orientations.

### DETAILED DESCRIPTION

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

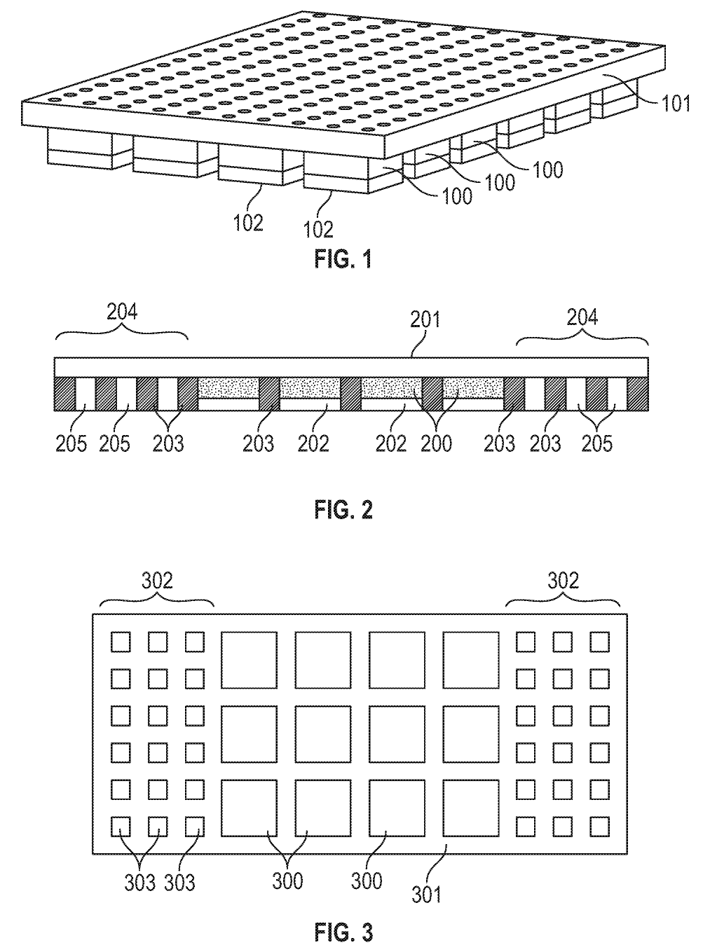

FIG. 1 illustrates an exemplary schematic of a field emitter electron source comprising one or more tiles of field emitter arrays sharing a common gate. Each field emitter array tile 100 comprises an array of surfaces which emit electrons when a sufficiently high electric field is applied to the surface. This electron field emission process can occur from multiple types of materials such as metals, semiconductors, dielectrics, and other nanostructures such as carbon nanotubes. The field emitter array tile may be composed of any material type that emits electrons in a field emission process. It may benefit the field emission process when each emission surface in the field emitter array is a sharp tip which enhances the electric field at the tip to allow field emission of electrons using a lower applied electric field. An array of sharp tips for use as a field emitter array may be created using deliberate fabrication, for example by using lithography and nanofabrication processes to sharpen an array of tips from a substrate material such as a metal or semiconductor. Or an array of sharp tips may also be created by using natural nanomaterial properties such as a surface coated in carbon nanotubes. The structure in FIG. 1 can be utilized broadly for any type of field emitter array tile or combinations of different types of field emitter array tiles.

The gate 101 is a conductive material that may be used to apply a voltage to the field emitter array tiles to induce an electric field to induce field emission of electrons from the field emitter array tile. The gate 101 may contain openings to allow the field emission generated electrons to pass through the gate. This gate is comprised of a conductive material or a combination of conductive materials, such as a metal or a highly doped semiconductor. We refer to this gate configuration illustrated in FIG. 1 as a “common gate” configuration where the same gate layer is used to control more than one field emitter array tile.

In an embodiment of the field emitter array electron source in FIG. 1, the emission surfaces in the field emitter array tiles 100 may protrude into the openings in the gate 101 for electrons to pass through. For example, field emitter array tiles that are fabricated as aligned arrays of sharp tips may further comprise aligned openings that are fabricated to surround each emission tip to apply an electric field to induce electron field emission from each tip.

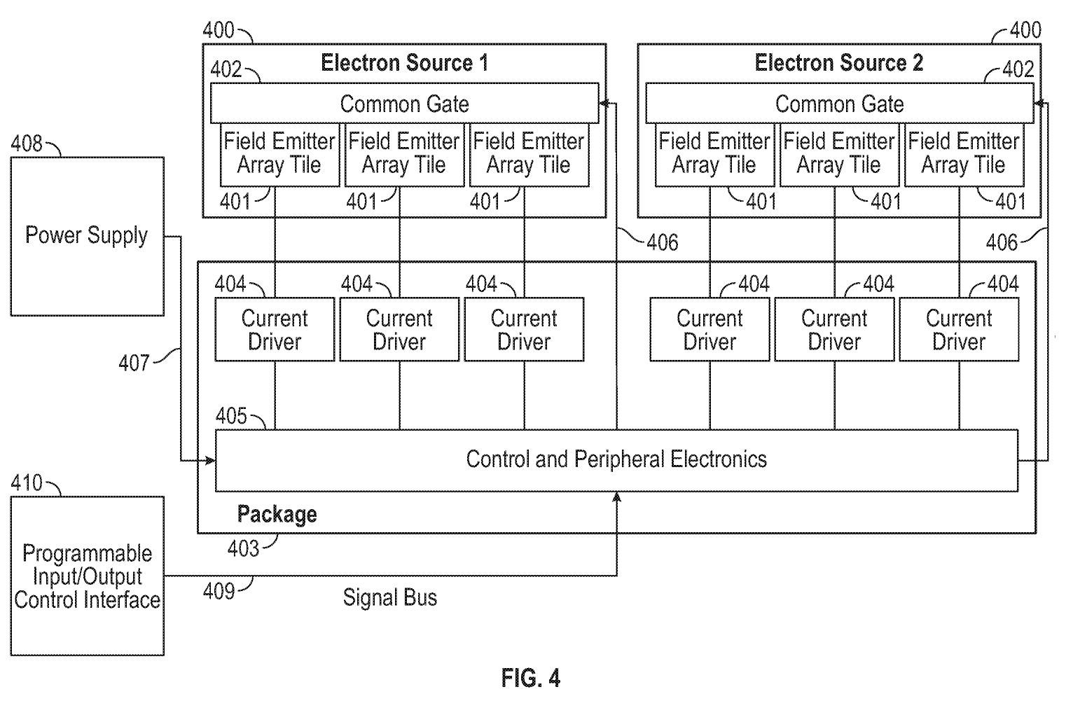

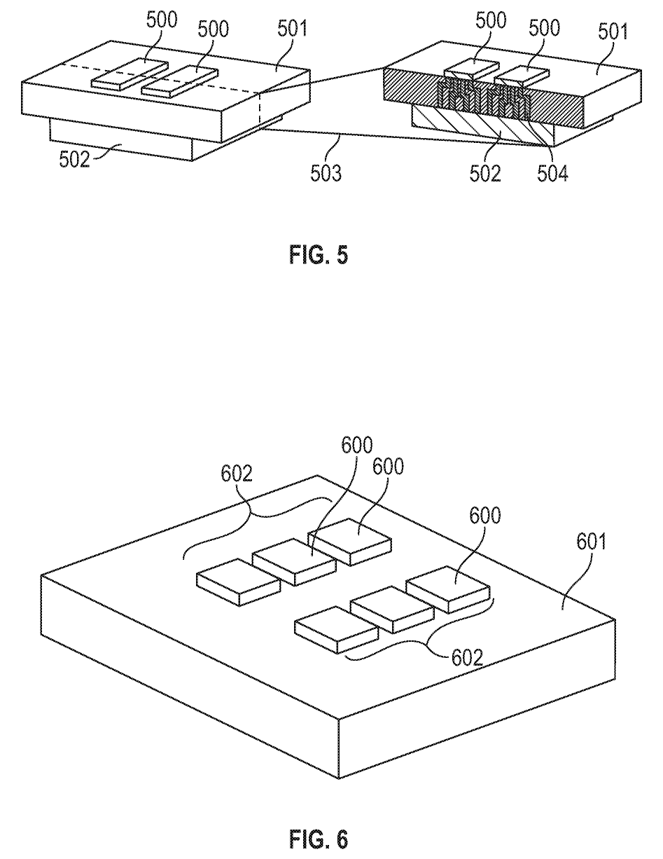

In an embodiment, each field emitter array tile 100 in the electron source may include a conductive material 102 bonded to the bottom of the tile as an electrical contact. This conductive material may be a metal bonded or alloyed to the field emitter tile. For example, for a field emitter array made of silicon, heating metals that form an alloy with silicon such as aluminum will form an efficient bonded self-aligned contact to each tile. In another embodiment, this material may be a highly doped region in the semiconductor for a field emitter array made from a semiconducting substrate material such as silicon. This conductive bonded layer may also serve as an intermediate joining layer to facilitate bonding to another substrate such as a cathode package as later described in FIG. 4 and FIG. 5.

FIG. 2 illustrates the electron source of FIG. 1 further comprising electrical isolation 203 between field emitter array tiles 200 using an electrically insulating material (with similar common gate 201 and conductive material on bottom of each tile 202 depicted). This electrical isolation material may be an insulator that can be deposited to fill less than about 10 micro-meter scale trenches, such as silicon oxide, tetraethoxysilane, or silicon nitride. Filling the gaps between field emitter array tiles with electrical insolation material may provide structural support for the electron source. The electrical isolation material may also improve thermal conductivity of the electron source versus unfilled gaps, which may benefit electrical performance and operation stability of the electron source.

In an embodiment, FIG. 2 further illustrates exemplary placement of gate contacts 205 to the gate layer 201 through the electrical isolation 203. In the embodiment depicted, the individual gate contacts 205 are grouped in gate contact regions 204 placed at the edges around the field emitter array tiles 200 in the electron source. Such a layout allows accessing all contacts to the gate 205 and each field emitter array tile 202 from the same side of the electron source. We refer to this side as the backside, and the electrons emit from the frontside containing the gate layer 201. Placing gate contact regions 204 at multiple edges of the electron source structure may reduce the longest electrical path to the center of the field emitter array, thereby reducing electrical resistance through the gate and reducing the resulting voltage drop towards the center of the field emitter array which sees the longest electrical path. The material of the gate contacts 205 may be a conductive material such as a metal or highly doped semiconductor. Electrical isolation material 203 electrically insulates the gate from the field emitter array tiles 200 and the conductive backside contacts 205 to each field emitter array tile. FIG. 3 further illustrates a top-down view of an exemplary backside layout of a field emitter array electron source that may correspond to FIG. 2, comprising field emitter array tiles 300 and gate contact regions 302 placed at the edges. FIG. 3 illustrates an embodiment where the gate contact regions are implemented as a two-dimensional array of multiple contact pillars 303 (which may be referred to as “vias”) embedded in electrical isolation 301. Although FIG. 3 depicts two gate contact regions 302, in some embodiments the field emitter array electron source may include a different number of gate contact regions (e.g. one, three, four, etc.) which may be at different locations. Further, although FIG. 3 depicts gate contact regions using an array of pillars, in other embodiments the gate contact regions may be comprised of other shapes or patterns, nonuniform patterns, or solid regions entirely filled with conductive material, or a ring surrounding the field emitter array tiles.

FIG. 4 illustrates an exemplary block diagram schematic of a cathode system utilizing one or more field emitter array electron sources 400. The cathode may be used as a subcomponent for multiple types of systems that need a source of electrons such as an x-ray tube, electron beam ionizers for a plasma chamber, or mass spectrometers. The cathode comprises a package 403 containing drivers 404 for controlling current from one or more field emitter array tiles 401, gate voltage control 406 for each gate 402, and electronics 405 for controlling and programming the electron sources. The control electronics in 405 may include elements such as gate voltage controllers, feedback circuitry for gate drivers to maintain constant output from each field emitter array tile or groups of tiles, current or voltage pulsing units, signal routers for selecting specific field emitter array tiles, memory elements for programming or calibrating field emitter array tiles, and sensors to monitor performance or temperature. The cathode may be configured such that the electron sources 400, driver electronics 404, and other electronics 405 used to control one or more field emitter array electron sources are attached to the same physical package substrate 403. Although FIG. 4 depicts two electron sources 400, in some embodiments the cathode may comprise a different number of electron source (e.g. one, three, four, etc.). The cathode may be powered from one or more input voltage or current sources 407 from an external power supply 408. The cathode may be controlled and programmed externally using a signal bus 409 for communicating input and output signals. An external programmable controller 410 which may use a microcontroller, a field-programmable gate array (FPGA), or other computing element may be used to facilitate communication with the cathode through the signal bus 409. The external programmable controller 410 may serve as an interface between one or more computers or data acquisition systems and one or more cathodes.

In an embodiment, the cathode in FIG. 4 is controlled externally using a digital signal bus 409 which are converted by the control electronics 405 to analog electrical signals for controlling the field emitter array tiles. These digital signals in the signal bus 409 may include electrical or optical signals. For example, a bus of multiple 5 V or lower digital signals would input to the electronics 405, which then triggers the output of certain field emitter array tiles using a much higher voltage than 5 V for the field emitter array tiles that is determined by the control circuitry 405. A benefit of this embodiment using digital triggering may be to reduce the time latency by using lower voltage digital signals, improve noise tolerance, and improve input signal voltage surge and electromagnetic interference (EMI) resistance. Another example would be to use a digital signal bus input 409 to the control electronics 405 to program calibration or other memory elements in 405 used to tune the electrical characteristics of individual field emitter array tiles 401 in the electron sources 400.

FIG. 5 illustrates an exemplary schematic of one or more electron sources 500 attached to a physical package substrate 501. The substrate is some physical structure that may facilitate attaching the electron sources and other peripheral components. An exemplary schematic cross-section 503 illustrates the interior of the package substrate may include electrical wiring 504 to connect to each individual field emitter array tile, gate contact regions, or other peripheral structures on the package. The electrical wiring 504 may be metal physically deposited and built into the package substrate during fabrication. This package structure with embedded metal wiring to the field emitter array tiles in each electron source provides benefits of both miniaturizing the electrical wiring to the electron source and providing a substrate comprising of high thermal conductivity metal wiring and high thermal conductivity ceramics such as aluminum oxide to improve the heat dissipation from the electron source. Because the electron beam output of a field emitter array depends on temperature, this structure may benefit the performance and stability of operation of the electron sources which may be exposed to high temperatures in environments such as an x-ray tube or electron tube.

In an embodiment, the field emitter array cathode may include field emitter array electron sources 500 and electronics 502 for operating the field emitter array electron sources bonded to the same package substrate 501. The electronics in 502 may include components corresponding to FIG. 4 which depicts the electronics in the package 403 such as current drivers for each field emitter array tile 401, gate voltage controllers, feedback circuitry in gate drivers to maintain constant output from each field emitter array tile or groups of tiles, current or voltage pulsing units, signal routers for selecting specific field emitter array tiles, memory elements for programming or calibrating field emitter array tiles, and sensors to monitor performance or temperature. The embedded electrical wiring 504 in the package substrate 501 may be used to connect signals from the electronics 502 to the field emitter array gates and multiple field emitter array tiles integrated on the same package substrate 501. A benefit of this embodiment is to reduce system parasitic resistance, capacitance, and inductance by putting all control electronics close to the field emitter arrays, which may improve cathode performance, control speed, operation stability, and electrical noise tolerance.

In an embodiment, the electronics 502 bonded to the package substrate may further include one or more transient voltage suppressing elements for the field emitter array electron sources 500 bonded to the same package substrate 501. These transient voltage suppressing elements benefit reducing damage to the field emitter arrays from large voltage surges or voltage ripples such as those induced by vacuum arcs. The transient voltage suppressing elements may include a diode, a thyristor, a capacitor, a metal oxide varistor, or another device that presents a low impedance to a surge of voltage at sub-microsecond time scale. The transient voltage suppressing element may also use a combination of these individual transient voltage suppressing element types. Electrical wiring in the package substrate 504 may connect the field emitter array tiles and gates to the transient voltage suppressing elements. The benefit of bonding the transient voltage suppressing element directly to the package substrate is to minimize impedance, particularly parasitic inductance, from the field emitter array electron sources to the transient voltage suppressing elements. The presence of parasitic inductance limits the effect of transient voltage suppressing elements and may also induce longer time scale voltage ripples after the main voltage surge event. The voltage surge and voltage ripples may cause permanent degradation of the field emitter arrays and may also cause unstable output performance of the field emitter array electron sources during the voltage surge event. The voltage surge and voltage ripples may also generate electromagnetic interference (EMI), which could induce voltage surges in peripheral electronics in the system, for example a computer, or an x-ray detector, or data acquisition circuitry. In cases where peripheral electronics are measuring data, such as in an x-ray system, the EMI may induce incorrect data to be collected, harmful to the accuracy of the system. Bonding transient voltage suppressing elements directly to the package substrate, rather than in an external circuit, may limit the amplitude of voltage surge and voltage ripples (for example those induced by vacuum arcs) by reducing parasitic inductance which may limit the EMI generated, thereby improving overall accuracy of the system behavior.

FIG. 6 illustrates an embodiment of a field emitter array cathode where each electron source operates as a group 602 comprising more than one unit of individual field emitter array electron source elements 600. Each field emitter array electron source group 602 may use electrical wiring in the package substrate 601 similarly described in FIG. 5 to connect the gates of individual field emitter array electron source units so that the units operate in aggregate as if they were a single electron source with a common gate and multiple controllable field emitter array tiles. A benefit of structuring each electron source unit from multiple sub-units of field emitter array electron sources may be enabling the same field emitter array electron source component to be used to generate different sizes, shapes, or arrangement patterns for the aggregate electron source.

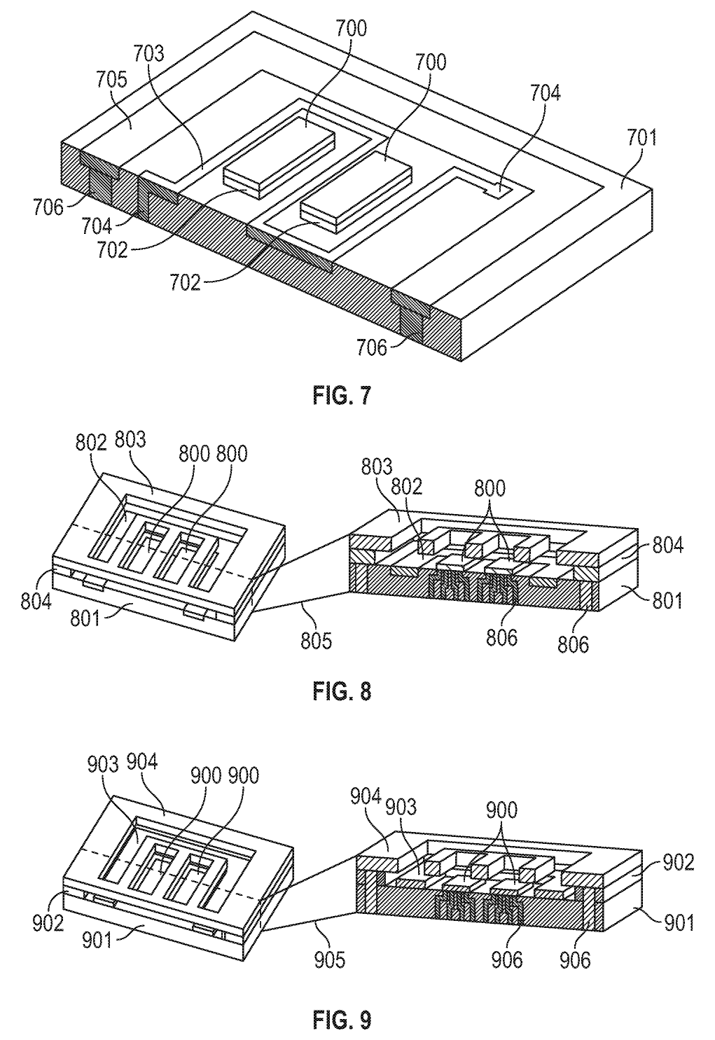

FIG. 7 illustrates an embodiment where each field emitter array electron source 700 is directly bonded on top of another controller die 702 containing circuit controllers for the field emitter array tiles, which is then bonded to the package substrate 701. Each bonded controller die 702 may include current drivers or gate voltage drivers for each field emitter array tile. Each bonded controller die 702 may also include feedback logic circuitry to stabilize output current for each individual tile or for groups of tiles or for the electron source in aggregate. Each bonded controller die 702 may also contain programmable memory and elements to set the output current in each tile. The benefit of placing the current or gate voltage drivers as close as possible to the field emitter arrays is to minimize parasitic voltage drop from wiring and to minimize parasitic delay from capacitance of longer routing. This benefits field emitter array tile output electron current accuracy and stability during operating, especially when feedback circuitry is embedded into the bonded controller die by minimizing the routing parasitic resistance, capacitance, and inductance. This additionally benefits miniaturization of a system using the field emitter array cathodes by integrating the controller electronics into a stacked die. This structure is reliably manufacturable for solid-state field emitter arrays that are fabricated on a semiconductor substrate. Stacking heterogenous semiconductor substrates containing different integrated circuitry, for example a field emitter array electron source die 700 and a semiconductor integrated circuit logic controller die 702, may be performed using die stacking techniques such as flip-chip bump bonding or through-silicon via metal-metal bonding. For x-ray systems, the stacked die controller structure may be a miniaturization advantage for field emitter array cathodes versus cathodes using thermionic emission to generate electrons from a heated material. The heat generated from thermionic emitters may damage most common electronics, which may require forms of active or passive cooling or sufficient thermal insulation for peripheral electrical components, which may increase the size, volume, and weight of the cathode assembly. For example, thermionic heated filaments may operate about as high as > 2000°C and dispenser cathodes may operate about as high as > 1000°C, and those temperatures are higher than the tolerable operating range of many common semiconductor integrated circuit components. Field emitter array cathodes may operate at low voltage ranges which would benefit minimizing the size of this stacked die structure by reducing the size of control electronics and electrical insulation required to avoid electrical breakdown.

FIG. 7 further illustrates an embodiment of the cathode package 701 further comprising embedded metal heater lines 704 for elevating the temperature of the package substrate 701 and electron sources 700. These may be used to heat the electron sources 700 to cure certain damage caused by radiation induced damage or ion backbombardment induced damage to the field emitter array field emission tips. High energy negative ions generated from electron ionization during operation in an x-ray source or plasma chamber are accelerated back to the cathode, inducing damage in the field emitter array tips when ions impact and displace the material lattice. Using the embedded heater lines to raise the temperature of the package substrate to anneal the field emitter array tips may repair limited amounts of material lattice damage, which may be used to restore field emitter array performance over the cathode operation lifetime. Electrical contacts to the heater line 704 may be routed to pass through the package substrate at multiple locations.

FIG. 7 further illustrates an embodiment of a cathode package 701 with field emitter array electron sources 700 further comprising a solid-state vacuum getter 705 material integrated onto the same package substrate. The solid-state getter may be some material that absorbs gas molecules to maintain a vacuum environment. This benefits the cathode performance and lifetime when required to operate in a sealed vacuum environment. The getter may be placed around the field emitter array electron sources 700, such as in a ring pattern. In some embodiments, electrical contacts in the package substrate may be routed underneath the vacuum getter 706 as heaters to elevate the temperature to re-activate the getter in a vacuum environment to extend the getter’s lifetime. These getter contacts 706 may pass through the substrate to allow contact from outside the vacuum environment. The getter may be placed on the surface or embedded into the package substrate. The embedded getter structure as illustrated in FIG. 7 may benefit the cathode by avoiding placing the getter protruding out of the package surface, which may block space required for placing other components close to the electron source surfaces. For example, electrostatic focusing elements as illustrated in FIG. 8 and FIG. 9 may benefit from placement at close sub-milli-meter scale distances to the field emitter array surface to increase electron beam steering modulation, and an embedded getter may facilitate easier alignment of the focusing element close to the electron source surface. In some embodiments, the cathode package may additionally comprise the heater lines 704 which may also be used to raise the temperature of solid-state vacuum getter 705 also attached or embedded to the package substrate, which may also serve to re-activate the getter to extend its lifetime.

FIG. 8 illustrates an exemplary embodiment of a field emitter array cathode further comprising a conductive electrostatic focusing element 803 which may be used for shaping or steering electron beams from each field emitter array electron source 800 that is bonded to the same package substrate 801. There may be an opening in the focusing element above each electron source 800, or multiple electron sources may share an opening. The focusing element may be held at a voltage level positive to the field emitter array gates in order to accelerate electrons from the field emitter arrays to the focusing element and through the openings. In other embodiments, the focusing element may be held at a different potential or floating. For example, in some embodiments, the potential may be set to steer the electrons into the focusing element to cut-off the electron beam emission from the cathode. The shape of the openings in the focusing element above each electron source may be designed to change the shape of the electron beam, to steer the electron beam, or to compress the electron beam from the electron sources. An exemplary schematic cross-section cut 805 illustrates the package substrate interior may include embedded electrical wiring 806 which may be used to connect to both the field emitter array electron sources and the focusing element. In an embodiment, the surface of the metal electrical wire 806 embedded in the package substrate may serve to facilitate metal-metal bonding to the focusing element which may benefit setting precise distance of the focusing element above each field emitter array electron source. The bond between the package metal electrical wire and the focusing element may be done directly or by using an interlayer metal. The focusing element 803 may be offset above the electron sources 800 with a conductive layer 804, which may be a layer of metal placed onto the package substrate 801 or may be part of the focusing element itself (for example, machined as part of the focusing element structure). In some embodiments, this conductive layer may serve to precisely set the distance from the electron source emission surface to the focusing element openings which may adjust how the focusing element affects the electron beam.

In some embodiments, a vacuum getter 802 may be included on the same package substrate as the electron sources 800 and focusing element 803. In some embodiments, the focusing element 803 may include openings to expose the getter to a vacuum environment above which may benefit the getter’s ability to absorb gas particles in the space above the cathode. Although the getter is depicted in FIG. 8 as embedded in the package substrate, in some embodiments the getter may sit on the surface of the package substrate 801 if there is sufficient space underneath the focusing element 803. Although not depicted, in some embodiments the embedded electrical wiring 806 may further comprise additional wires similar to 706 that connect to the getter 802, to heat the getter to activate or re-activate the getter during operation to extend the getter’s lifetime.

FIG. 9 illustrates another embodiment of a cathode package 901 including electron sources 900, an electron beam focusing element 904, and may further comprise a vacuum getter 903. In this embodiment, the focusing element 904 is offset above the electron sources 900 with a raised layer 902 which is part of the package substrate 901. Similar to FIG. 8, the electron beam focusing element 904 includes openings above the electron sources to shape the electron beam from the electron source. An exemplary schematic cross-section cut 905 illustrates the package substrate interior may include embedded electrical wiring 906 which may be used to connect to both the field emitter array electron sources and the focusing element. The embedded wiring 906 may pass through the raised package substrate layer 902 to connect to the focusing element 904. FIG. 9 may further comprise a vacuum getter, and the focusing element 904 may further comprise additional openings above the getter 903 which may benefit the getter’s ability to absorb gas particles in the space above the cathode. Although the getter is depicted in FIG. 9 as placed on the package substrate, in some embodiments the getter may be embedded in the package substrate 901. Although not depicted, in some embodiments there may be additional wiring 906 that connect to the getter 903, to heat the getter to activate or re-activate the getter during operation to extend its lifetime.

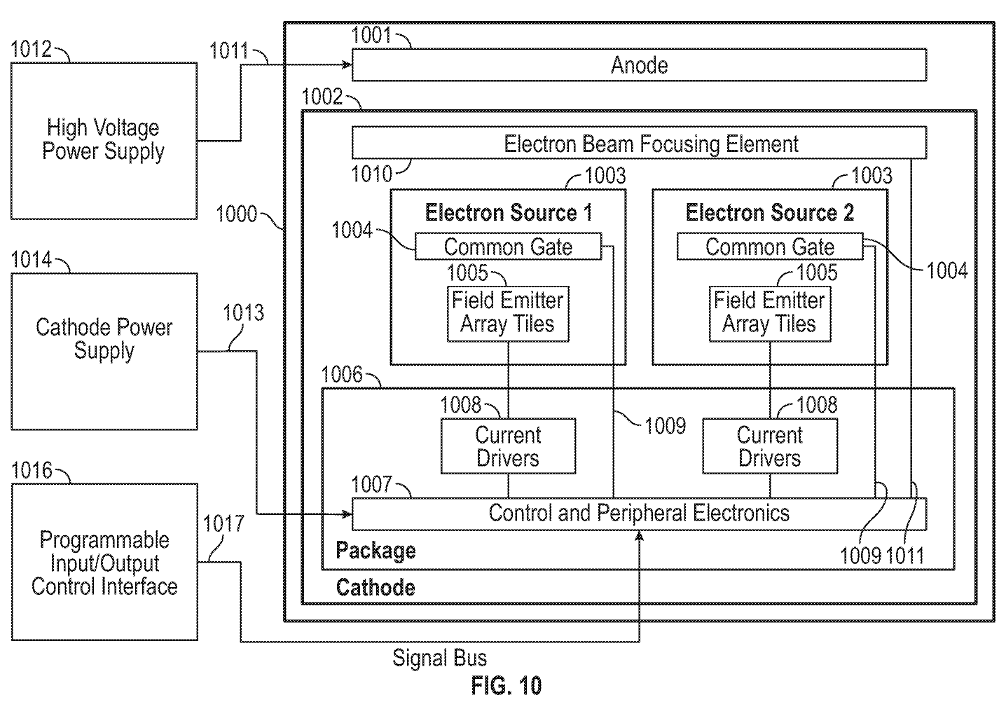

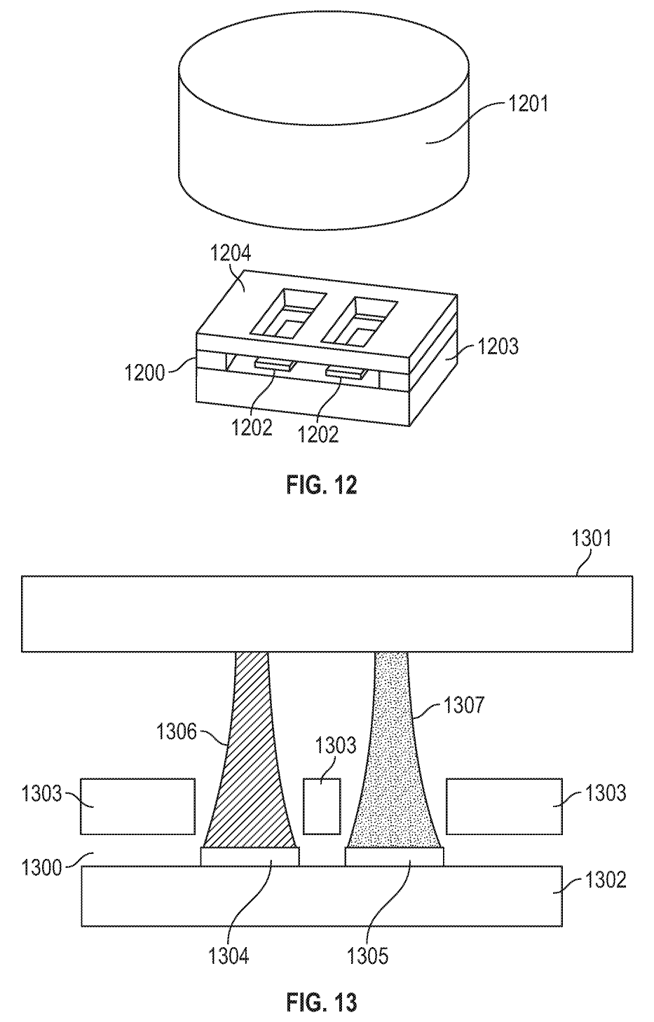

FIG. 10 illustrates an exemplary block diagram schematic of an apparatus to control electron flow 1000 comprising a field emitter array cathode 1002 and a metal anode 1001. An exemplary application of such apparatus is an x-ray generation system, where 1000 may be referred to as an x-ray source in such application. X-rays are generated through bremsstrahlung after accelerating electrons from the cathode into the anode using a positive electric field applied from the anode to the cathode. The anode 1001 is held at a positive high voltage relative to the cathode 1002, so such configuration illustrated in FIG. 10 is referred to as a “positive-anode” configuration system. The high voltage is applied 1011 from an external high voltage power supply 1012. The field emitter array cathode 1002 corresponds to the exemplary tiled field emitter array cathode block diagram previously depicted in FIG. 4 and further comprising an electron beam focusing element 1010 (exemplary illustration in FIG. 12). The cathode comprises one or more electron sources 1003 comprising multiple field emitter array tiles 1005 with a common gate 1004. Although FIG. 10 depicts two electron sources 1003, in some embodiments the cathode may comprise a different number of electron source (e.g. one, three, four, etc.). The electron sources 1003 are attached to the cathode package 1006 which may include control electronics 1007, current drivers for the field emitter array tiles 1008, voltage controls for each common gate 1009, and voltage control for the focusing element 1011. The cathode package is powered with an input voltage or current source 1013 from an external cathode power supply 1014. As previously described for the cathode illustrated in FIG. 4, an external programmable controller 1016 which may use a microcontroller, FPGA, or other computing element may be used to facilitate communication with the cathode 1002 through a signal bus 1017. The external programmable controller 1016 may serve as an interface between one or more computers or data acquisition systems and one or more cathodes. In some embodiments, the signal bus may be comprised of low voltage electrical or optical digital signals.

Although the following descriptions of embodiments of such system will be discussed for x-ray generation as an example, they may be broadly applicable to other applications utilizing controlled electron flow. Some additional examples include vacuum electron tubes (for example, traveling wave tubes, klystrons), linear accelerators, and electron impact ionizers (for example, in mass spectrometers and plasma generation systems). Hence, while the following descriptions may refer to such an apparatus 1000 as an x-ray source for illustrative purposes, it will nevertheless be understood that embodiments of this present disclosure are not limited to x-ray generation applications.

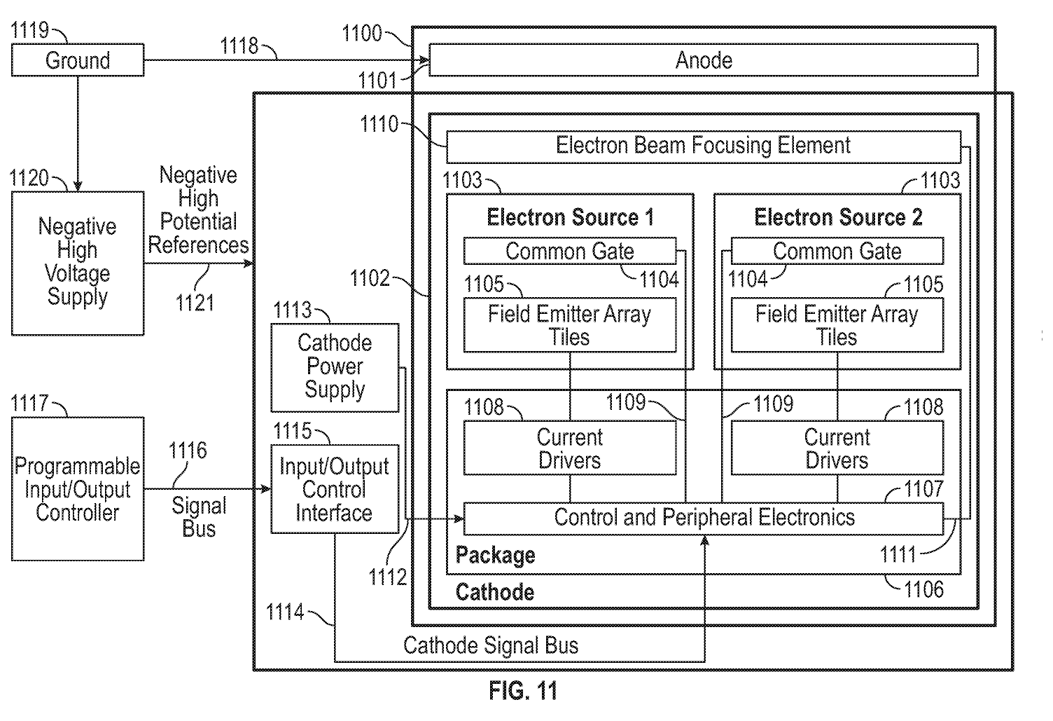

FIG. 11 illustrates a block diagram schematic of another embodiment of the system similar to FIG. 10, including an apparatus to control electron flow 1100 comprising a field emitter array cathode with similar elements as in FIG. 10, but instead with an anode 1101 configured at ground potential 1118, while the cathode 1102 ground is floating and elevated to a negative high voltage potential relative to the anode. This configuration in FIG. 11 may be referred to as “grounded-anode” configuration. Electrons will still accelerate from the cathode to the anode as there is a positive electric field from anode to cathode. The cathode 1102 includes similar elements attached to a cathode package substrate 1106 as previously described for FIG. 10, including one or more electron sources 1103 containing field emitter array tiles 1105 with a common gate 1104, control electronics 1107, current drivers for each field emitter array tile 1108, voltage control for each electron source common gate 1109, and voltage control 1111 for the electron beam focusing element 1110. In this embodiment, the cathode ground is floating and isolated from the system ground. The cathode ground is raised to a high negative potential 1121, which may be generated for example by an external negative high voltage power supply 1120 (which is referenced to the anode ground 1119) and an isolation transformer as needed. The cathode input voltage or current source 1112 from the cathode power supply 1113 is now referenced relative to the cathode negative ground potential. External computer systems and data acquisition systems are referenced to the system ground (i.e., anode ground 1119). To communicate with and program the x-ray source cathode, an external controller 1117 referenced to the system ground may use a signal bus 1116 that passes through the floating ground reference barrier to communicate with a cathode control interface 1115 referenced to the cathode negative ground potential 1121. The external controller 1117 may include a microcontroller, FPGA, or other computing elements. The external signal bus 1116 may use a transformer or optical signals to pass from the external system using the system ground reference potential to the cathode system with a negative floating ground potential reference. The cathode control interface 1115 converts the external signal bus 1116 into a cathode signal bus 1114 for controlling the cathode. This cathode signal bus 1114 is similarly described for previous FIG. 4 and FIG. 10.

Embodiments of the cathode previously described and of the field emitter array electron flow control apparatus to be described apply to positive-anode, grounded-anode configurations, as well as other bias configurations where the anode and cathode are at different potential offsets. Positive-anode and grounded-anode are two illustrative examples showing how the same field emitter array electron flow apparatus can be configured for multiple anode-cathode bias configurations. The same apparatus (1000 and 1100) and signal interface (1017, 1114, and 1116) embodiments to be described below may be applied to multiple anode-cathode bias configurations.

FIG. 12 illustrates an exemplary schematic of a configuration of a cathode 1200 and anode 1201 for an embodiment of an apparatus to control electron flow (e.g. 1000 and 1100 previously described for FIG. 10 and FIG. 11). The cathode may include one or more field emitter array electron sources 1202 and an electron beam focusing element 1204 on a package substrate 1203. The cathode 1200 may include aspects of a field emitter array cathode previously described in FIG. 5-9. Though only one anode is depicted and described in the following descriptions, in some embodiments the anode may comprise a module of multiple anode targets. Each of the multiple anodes may comprise of a different material. Each of the multiple anodes may be configured with different bias voltages, such as from a high voltage power supply module 1012 that outputs multiple high voltage values 1011 to each anode in an anode module.

FIG. 13 illustrates an exemplary cross-section schematic of an embodiment of an apparatus to control electron flow including the cathode 1300 and anode 1301. The electron sources 1304 and 1305 and the focusing element 1303 are integrated into a cathode package substrate 1302. Wiring inside the package substrate, for example previously described for FIG. 5 and FIG. 8-9, may be used to control the electron sources to generate an electron beam and to configure the electrostatic focusing characteristics of the focusing element 1303. During operation, a positive electric field is applied from the anode 1301 to focusing element 1303, and a positive electric field is applied from the focusing element 1303 to the electron sources 1304 and 1305. As an example of operation, electron source 1304 may be turned on to generate an electron beam 1306 that is shaped by the electric field from the focusing element 1303 and the geometry of the focusing element opening above the electron source. In some configurations, the other electron source 1305 may not be turned on and does not generate its electron beam (whose electron beam may be like 1307). Although FIG. 13 depicts two electron sources, in some embodiments the cathode may include a different number of electron sources and their corresponding focusing element openings (e.g. one, three, four, etc.) at different locations. In some embodiments using more than one electron source, more than one electron source may be turned on simultaneously so that there may be multiple electron beams at the same time emanating from more than one electron source. For example, the structure in FIG. 13 may alternatively be configured using electrical wiring and controls through the package substrate 1302 such that electron source 1304 may be turned off and 1305 be turned on, or both 1304 and 1305 may be turned on or off simultaneously.

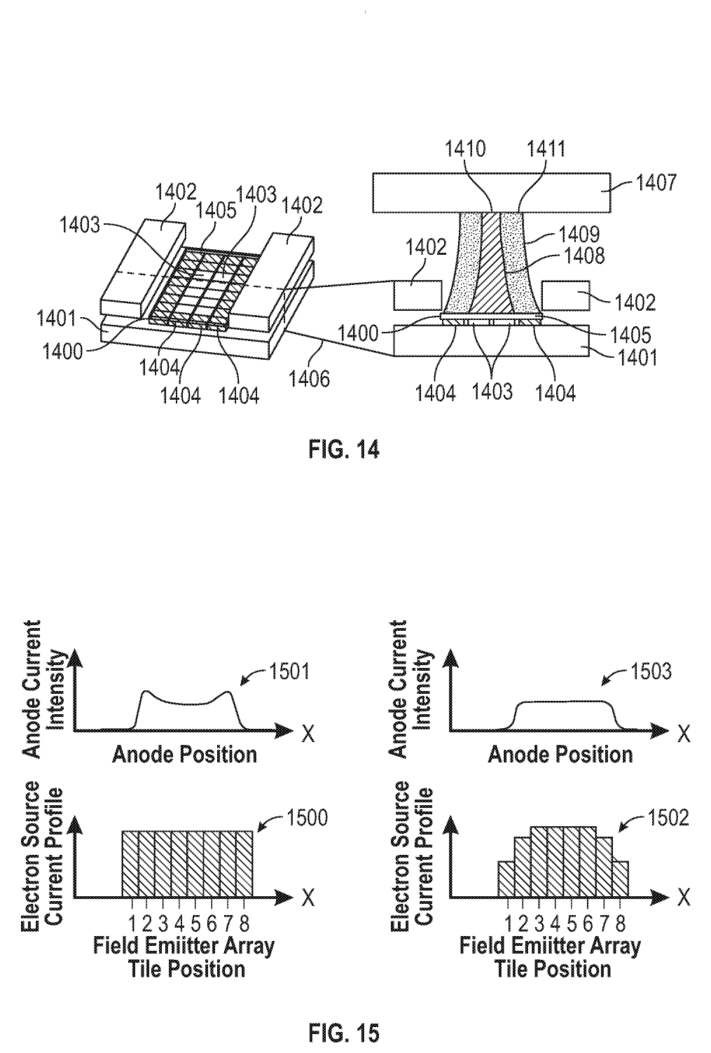

FIG. 14 depicts an embodiment of an apparatus to control electron flow configured with a cathode configured with a tiled field emitter array electron source 1400. The tiled field emitter array electron source is like that previously described in FIG. 1-3 including multiple field emitter array tiles (e.g. 1403 and 1404) and a common gate 1405. The tiled electron source is integrated on a cathode package substrate 1401 which may further comprise a focusing element 1402. This electron source may represent one of the one or more electron sources in the cathodes depicted in FIG. 10 and FIG. 11. Under one example of operation, the field emitter array tiles 1403 are turned on (i.e. configured to emit electrons), which produces electron beam 1408 that passes through the focusing element towards the anode 1407, while tiles 1404 are turned off (i.e. configured to not emit electrons). The electron beam reaches the anode generating a focal spot pattern 1410.

Under another example of operation, all the emitter tiles 1403 and 1404 may be turned on, which may generate a larger electron beam 1409 and larger focal spot region on the anode 1411. For the application of bremsstrahlung x-ray generation by striking a metal anode with high energy electrons, changing the size and shape of the focal spot on the anode may be used to change x-ray imaging characteristics such as the penumbral blur which may affect imaging resolution. X-ray flux generated may be configured by increasing or decreasing the current emitted from the electron source tiles. FIG. 14 illustrates just one example of a subset of the field emitter array tiles turned on and the remaining turned off. Other electron beam and focal spot sizes, shapes, and patterns may be generated by turning other emitter tile subsets on and off. This mode of tiled emitter operation (turning certain field emitter array tiles on and others off) applies to other embodiments of tiled field emitter array electron sources with different tile array dimensions, size of tiles, non-uniform tile sizes, etc.

FIG. 15 illustrates an example of configuring the anode electron current intensity profile by configuring the tiled field emitter array spatial current emission profile by controlling the electron current from each field emitter array tile. The anode electron current intensity profile may be used to configure the focal spot spatial intensity profile on the anode. For example, from a tiled field emitter array electron source such as the one depicted in FIG. 14, the electron source current profile along one spatial axis illustrated in 1500 and 1502 may be configured by controlling the current emitted from each field emitter array tile along that spatial axis as indicated on the horizontal axis. The electron current from each field emitter array tile may be individually configured to different values by applying different electric fields from the gate to each tile’s field emitters. In an embodiment, the electric field applied to each field emitter array tile may be controlled using the cathode control electronics and the driver for each tile to set a different gate-emitter voltage on each tile to output a specific current (or to apply zero electric field to turn a tile off). In another embodiment, the cathode control electronics may additionally use feedback circuitry to force each driver to make its field emitter array tile output a constant programmable current value (or to turn it off). In one electron source current configuration 1500, the output of each field emitter array tile current is uniform for each tile position labelled on the horizontal axis of 1500, which may generate a corresponding current intensity profile on the anode (the focal spot intensity profile) 1501, which may exhibit humps. In another electron source current configuration 1502, the field emitter array tile currents may be individually configured to generate the profile 1502, which may generate a current intensity profile on the anode 1503 with reduced humps. In other embodiments, other arbitrary focal spot intensity profiles on the anode may be generated by adjusting the current profile of the electron source by modulating the individual field emitter array tile currents. In other embodiments, non-uniform current from each field emitter array tile may be combined with turning certain field emitter array tiles entirely off to change the size, shape, pattern, and intensity profile of the focal spot on the anode.

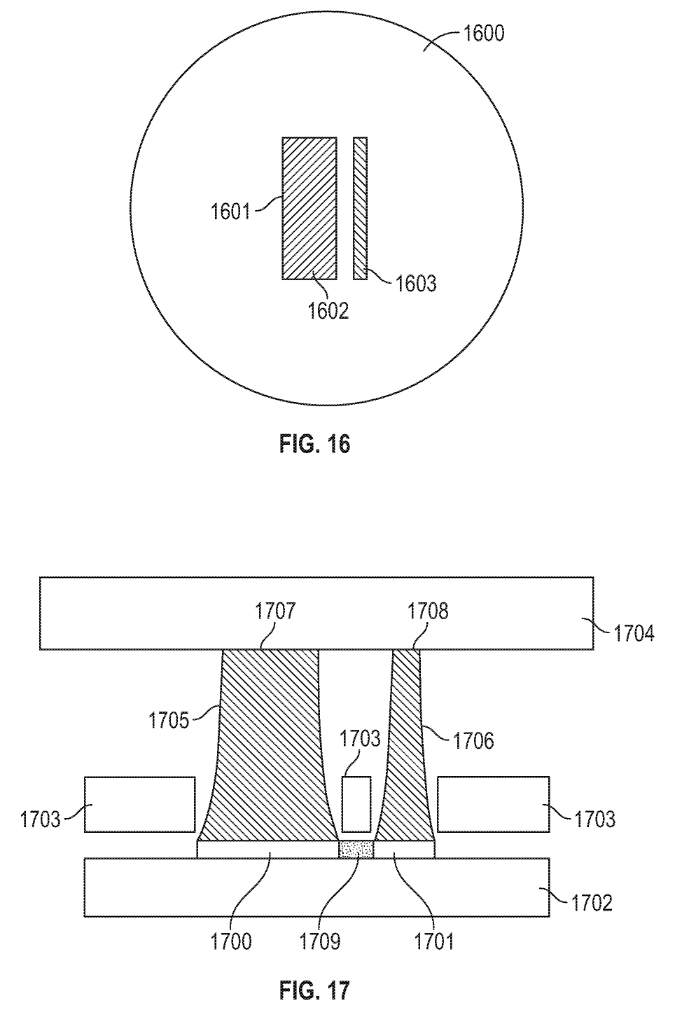

FIG. 16 illustrates an example of a focal spot pattern 1601 on an anode 1600 comprising two disjoint focal spot regions comprising a large spot 1602 and small spot 1603. This is termed a “multi-modal” focal spot. Any focal spot pattern comprising two or more disjoint focal spot regions which may be of different sizes and shapes may be described as a multi-modal focal spot. A multi-modal focal spot combining a large and one or more smaller disjoint focal spot regions simultaneously may improve x-ray computed tomography (CT) imaging resolution by reducing signal noise variance versus performing CT using conventional focal spot patterns which are rectangular or ellipsoidal blobs in shape.

In an embodiment illustrated in FIG. 17, an apparatus to control electron flow may be configured to generate a multi-modal focal spot regions 1707 and 1708 on the anode 1704 with one electron source comprising regions 1700, 1709 and 1701 (which may be one of the one or more electron sources in a cathode) on a cathode package substrate 1701 by configuring a focusing element 1703 to mask a region of the electron emission (i.e. block or absorb the electron beam). In this embodiment, the entire electron source may be turned on or specific tiles in the electron source may be turned on in a tiled field emitter array electron source. Electron source regions covered by the focusing element should have emission to the anode blocked and absorbed into the focusing element. The focusing element may include more than one asymmetrically sized openings to force electron beams into a large beam 1705 (which generates corresponding large focal spot region 1707 on the anode) and one or more smaller beams 1706 (which generates one or more small focal spot regions 1708 on the anode). Although the embodiment in FIG. 17 depicts two openings in the focusing element, in other embodiments there may be more than two asymmetrically sized openings in the focusing element to generate other multi-modal focal spot patterns. Although not illustrated, within the field emitter array electron source, the field emitter array tiles output current profile may be modulated similar to FIG. 15 to generate arbitrary focal spot intensity profiles within each multi-modal focal spot region 1707 and 1708.

In another embodiment, FIG. 17 may depict an apparatus to control electron flow comprising two separate electron sources 1700 and 1701 on the cathode package substrate 1702 with different sizes, which may be configured to generate a multi-modal focal spot on the anode 1707 (comprising simultaneous disjoint large focal spot region 1707 and small region 1708) from the different emission area sizes from each electron source. The cathode may comprise a focusing element 1703 with openings sized correspondingly to each emitter area, such as a large opening for the larger electron source 1700 and a smaller opening for the smaller electron source 1701. A focusing element portion may still be placed between the two electron sources to facilitate shaping the large electron beam 1705 and small electron beam 1706 to form a desired multi-modal focal spot pattern. Although the embodiment in FIG. 17 depicts two electron sources with different sizes (and their respectively sized openings in focusing element), in other embodiments there may be more than two asymmetrically sized electron sources (and respective openings in the focusing element) to generate other multi-modal focal spot patterns. Although not illustrated, within each field emitter array electron source 1700 and 1701, the field emitter array tile output current profiles may be modulated similar to FIG. 15 to generate arbitrary focal spot intensity profiles within each multi-modal focal spot region 1707 and 1708.

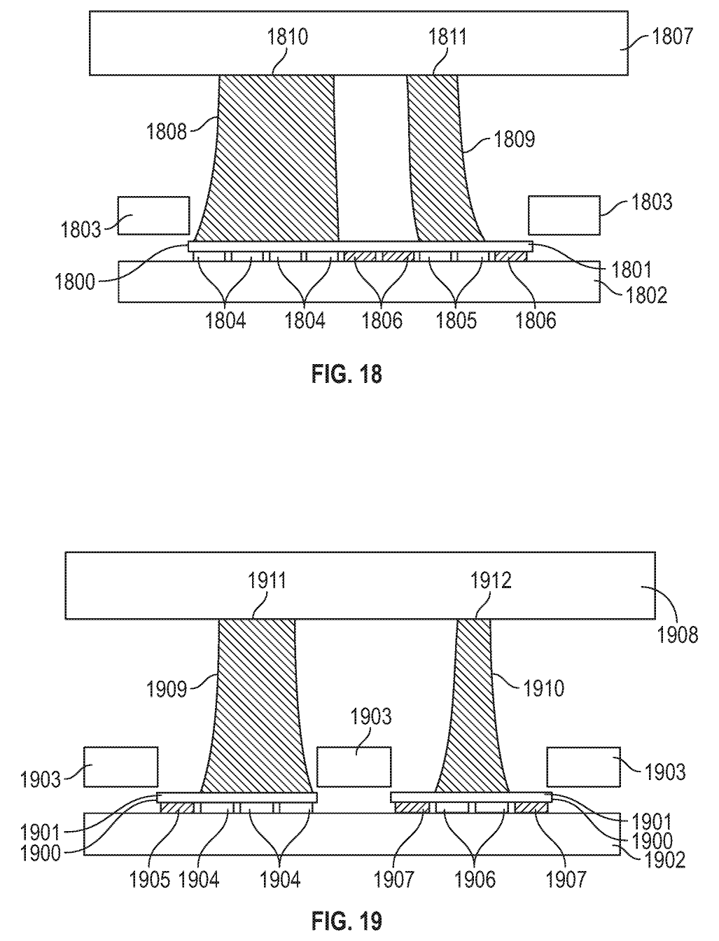

In another embodiment illustrated in FIG. 18, an apparatus to control electron flow may comprise a tiled field emitter array electron source 1800, which may represent one of the one or more field emitter array electron sources in a cathode (which may comprise a common gate 1801, package substrate 1802, and focusing element 1803), and may be configured to generate a multi-modal focal spot 1810 and 1811 on the anode 1807 by turning specific electron source tile groups 1804 and 1805 on and remaining tiles 1806 off. For the example illustrated in FIG. 18, a larger group of tiles 1804 is turned on to generate a larger electron beam 1808 and its respective larger focal spot region on the anode 1810, and a smaller group of tiles 1805 is turned on to generate a smaller electron beam 1809 and its respective smaller focal spot region on the anode 1811. Although the embodiment in FIG. 18 depicts two regions of field emitter array tiles turned on (four tiles on in 1804 and two on in 1805), in other embodiments each group of on tiles may be of different counts, and there may be more than two groups of on tiles, to generate different multi-modal focal spot patterns on the anode. Although not illustrated, within each group of field emitter array tiles that is turned on, the field emitter array tile output current profile may be modulated similar to FIG. 15 to generate arbitrary focal spot intensity profiles within each multi-modal focal spot region on the anode.

In another embodiment illustrated in FIG. 19, an apparatus to control electron flow comprising at least two tiled field emitter array electron sources 1900 may be configured to generate a multi-modal focal spot on the anode 1908. The two electron sources illustrated may represent two of the two or more electron sources in cathode, each with its own common gate 1901, shared cathode package substrate 1902, shared focusing element 1903, and anode 1908. Within each field emitter array electron source, groups of tiles may be turned on and off. For example, in one electron source a larger group of tiles 1904 may be turned on (and remaining tiles 1905 turned off) to generate a larger electron beam 1909 and respective larger focal spot region on the anode 1911, and in the other electron source a smaller group of tiles 1906 may be turned on (with respective remaining tiles 1907 turned off) to generate a smaller electron beam 1910 and respective smaller focal spot region on the anode 1912. In other embodiments, different subsets of tiles in each field emitter array may be turned on and off to generate other multi-modal focal spot patterns on the anode. Additionally, in other embodiments there may be more than two electron sources to generate other multi-modal focal spot patterns with more than two spots on the anode. Although not illustrated, within each group of field emitter array tiles that is turned on, the field emitter array tile output current profile may be modulated similar to FIG. 15 to generate arbitrary focal spot intensity profiles within each multi-modal focal spot region on the anode.

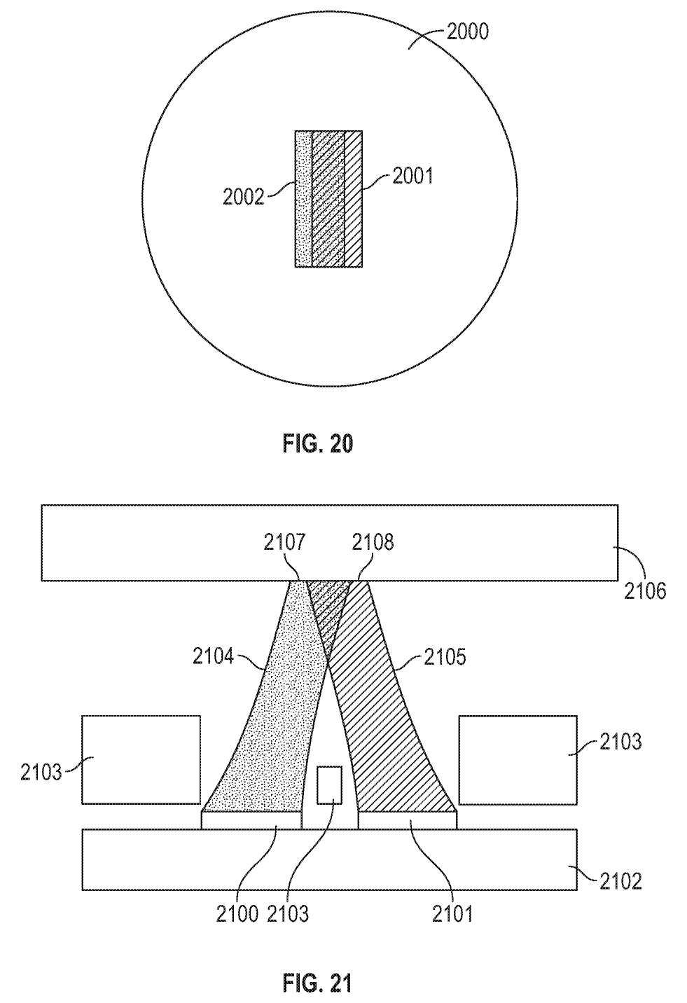

FIG. 20 illustrates two partially overlapped and offset focal spots 2001 and 2002 on an anode 2000. Rapidly alternating between the two offset focal spots, sometimes referred to as “flying focal spot”, may increase the number of projections during x-ray imaging to increase spatial resolution or reduce aliasing artifacts (e.g. by increasing the sampling rate). In other electron tube applications, rapidly changing the focal spot location may benefit reducing local surface heating on an anode.

In an embodiment illustrated in FIG. 21, an apparatus to control electron flow comprising two electron sources 2100 and 2101 may be configured to generate overlapped and offset focal spots 2107 and 2108 on the anode 2106 with a focusing element 2103 whose geometry is configured to steer the electron beams 2104 and 2105 from each electron source to partially overlap their respective focal spots on the anode. These two electron sources may be two of the two or more on a cathode package substrate 2102. The focal spots on the anode 2107 and 2108 may be rapidly alternated by pulsing on and off one electron source 2100 (which generates electron beam 2104 and focal spot 2107) then pulsing on and off the other electron source 2101 (which generates electron beam 2105 and offset focal spot 2108) and then repeating this pulsing. Although not illustrated in FIG. 21, in some embodiments, the electron sources may be field emitter array electron sources whose individual emitter tiles may be turned on and off to fine tune the focal spot locations on the anode. For example, the left focal spot 2107 may nominally use a center subset of the tiles in field emitter array electron source 2100 to set a nominal focal spot location, then may use a left subset of the tiles to generate a left shifted focal spot, or may use a right subset of the tiles to generate a right shifted focal spot. Turning a subset of tiles on or off to offset the focal spot location on the anode may be used to program or calibrate the desired focal spot offset between two focal spots 2107 and 2108.

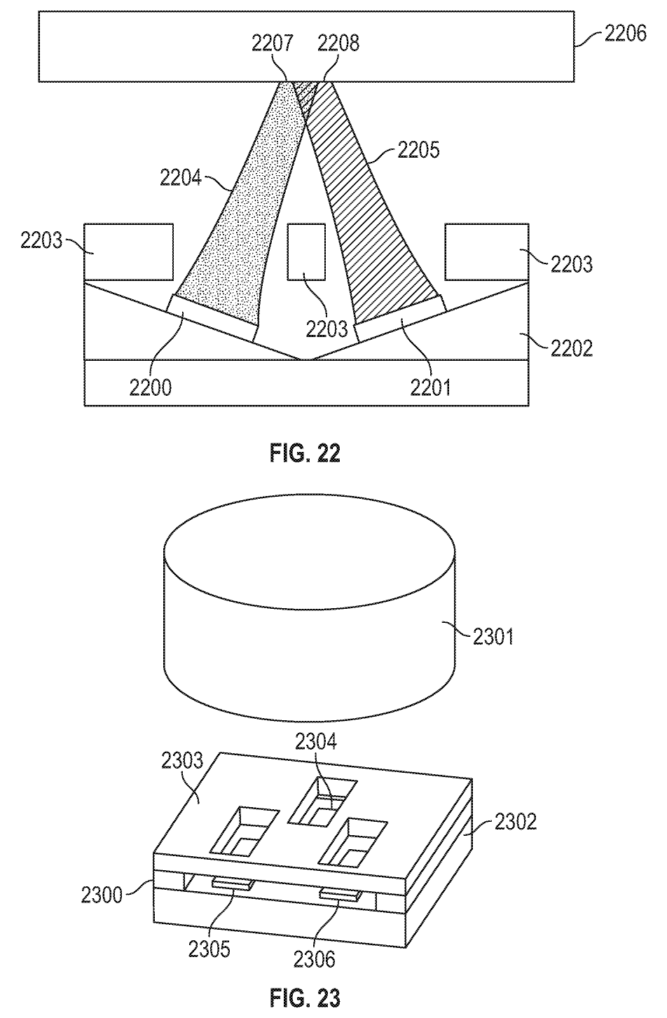

In another embodiment illustrated in FIG. 22, an apparatus to control electron flow comprising two electron sources 2200 and 2201 may be configured to generate overlapped and offset focal spots 2207 and 2208 on the anode 2206 with a package substrate 2202 configured to orient each electron source 2200 and 2201 to steer their emitted electron beams 2204 and 2205 towards the desired offset focal spot locations 2207 and 2208 on the anode 2206. In some embodiments, the cathode may further comprise a focusing element whose geometry 2203 may also be configured to assist in directing the electron beams to partially overlap on the anode. The angling to orient each electron source may be built directly as part of the package substrate geometry 2202. The focal spots on the anode 2207 and 2208 may be rapidly alternated by pulsing on and off one electron source 2200 (which generates electron beam 2204 and focal spot 2207) then pulsing on and off the other electron source 2201 (which generates electron beam 2205 and offset focal spot 2208) and then repeating this pulsing. Although not illustrated in FIG. 22, in some embodiments, electron sources 2200 and 2201 may be field emitter array electron sources whose individual emitter tiles may be turned on and off to fine tune the focal spot locations on the anode (similarly described for the embodiment FIG. 21).

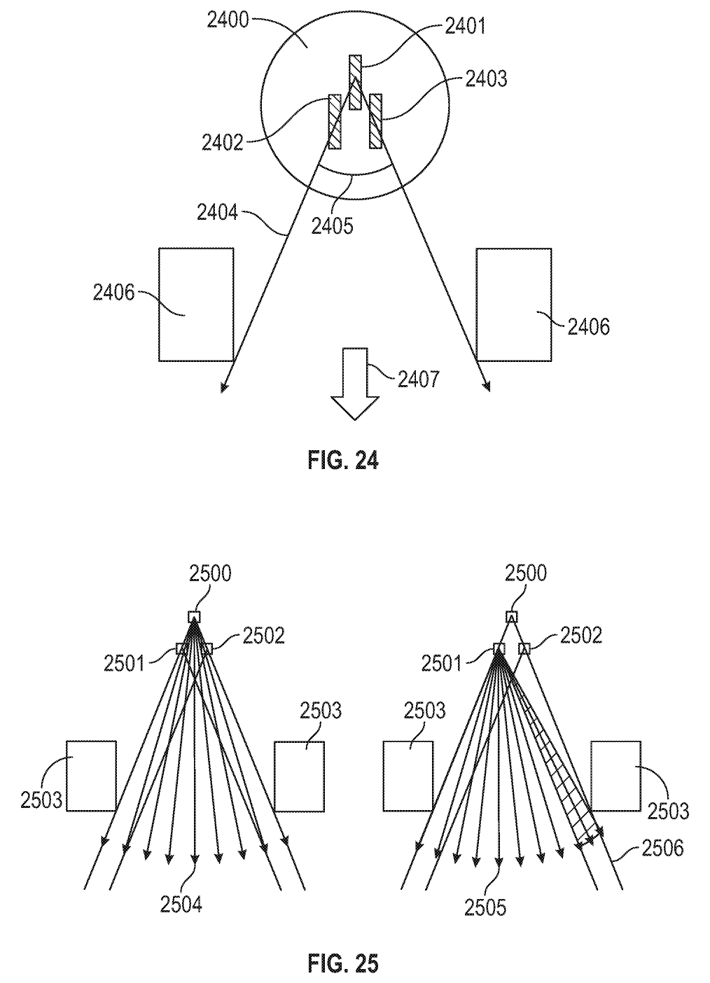

In an embodiment, FIG. 23 illustrates an apparatus to control electron flow comprising a cathode 2300, focusing element 2303, and anode 2301, where the cathode electron sources on the package substrate 2302 are arranged with one center electron source 2304 and two adjacent electron sources on each side 2305 and 2306 that are offset relative to the center source in a triangle-like pattern. For an x-ray generation application, FIG. 24 illustrates that the side sources 2305 and 2306 may be aligned in a triangular pattern to generate a corresponding focal spot pattern 2401, 2402, and 2403 on the anode 2400 where the side focal spots are aligned to the central spot’s target x-ray beam 2404 angle 2405. The x-ray beam spreads in the direction 2407 towards the x-ray target, such as an imaging subject or detector. The offset focal spot arrangement on the anode corresponds to the electron source layout, where electron source 2304 is configured to generate focal spot 2401, electron source 2305 is configured to generate focal spot 2402, and electron source 2306 is configured to generate focal spot 2403. The center focal spot’s 2401 x-ray beam 2404 may be collimated by x-ray collimation elements 2406 (which may be made from x-ray absorbing materials such as lead or tungsten) aligned to a desired beam angle 2405. The side focal spots 2402 and 2403 align to the edges of the center focal spot’s desired x-ray beam angle 2405.

FIG. 25 illustrates exemplary x-ray fan or cone beam cross-sections generated corresponding to the focal spot layouts illustrated in FIG. 24 (focal spot 2401 corresponds to focal spot 2500, focal spot 2402 corresponds to focal spot 2501, and focal spot 2403 corresponds to focal spot 2502). The x-ray beam 2504 generated from the center focal spot 2500 travel in the direction towards an x-ray subject and may be aligned to x-ray beam collimation elements 2503. The focal spot pattern 2501, 2502, and 2500 may be configured so that the x-ray beam 2505 generated from the side focal spot 2501 is aligned within the x-ray beam of the center focal spot 2500. By symmetry with 2501, the other side focal spot 2502 may be configured to also align its generated x-ray beam within the center focal spot’s generated x-ray beam. The side focal spots may generate additional beam angle 2506. The x-ray collimation element 2503 may be configured so that its aperture for x-rays to pass through is sized to accommodate the x-ray beam angle generated from all focal spots on the anode.

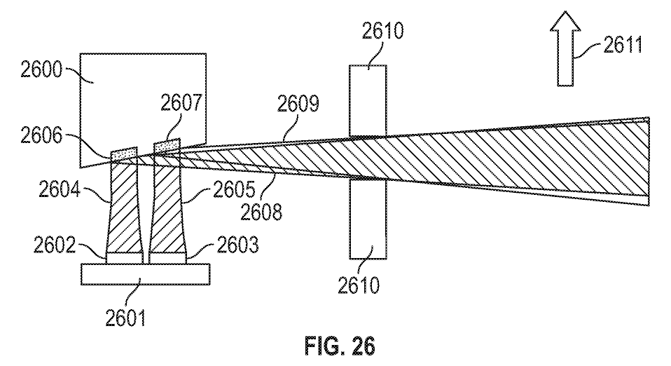

FIG. 26 illustrates an exemplary side profile cross-section schematic of an embodiment of an apparatus to control electron flow comprising a cathode 2601 with offset electron sources 2602 and 2603 and an angled anode target 2600. The rear electron source 2602 may correspond to the center electron source 2304 of FIG. 23 and the front electron source 2603 may correspond to either side electron source 2305 or 2306 of FIG. 23. The rear electron source 2602 generates a corresponding rear electron beam 2604 and rear focal spot 2606 on the anode. The front electron source 2603 generates a corresponding front electron beam 2605 and front focal spot 2607 on the anode. The angled anode may displace the x-ray beam 2608 generated from the rear focal spot 2606 relative to the x-ray beam 2609 generated from the front focal spot 2607 along a spatial z-axis 2611. The displaced x-ray beams may travel towards an x-ray beam collimator 2610 which may have an aperture sized to accommodate both rear and front x-ray beams. Such displacement may be appropriately binned and interpolated during an x-ray CT scan. In some embodiments, the displacement between x-ray beams 2608 and 2609 along the spatial z-axis may be designed to be small enough so that the electron sources 2602 and 2603 may be rapidly turned on and off, which may be used to increase sampling rate along the spatial z-axis during x-ray imaging, which may benefit increasing views or be used for anti-aliasing. In some embodiments, the displaced focal spots 2606 and 2607 on the anode may be used to reduce local surface heating on the anode.

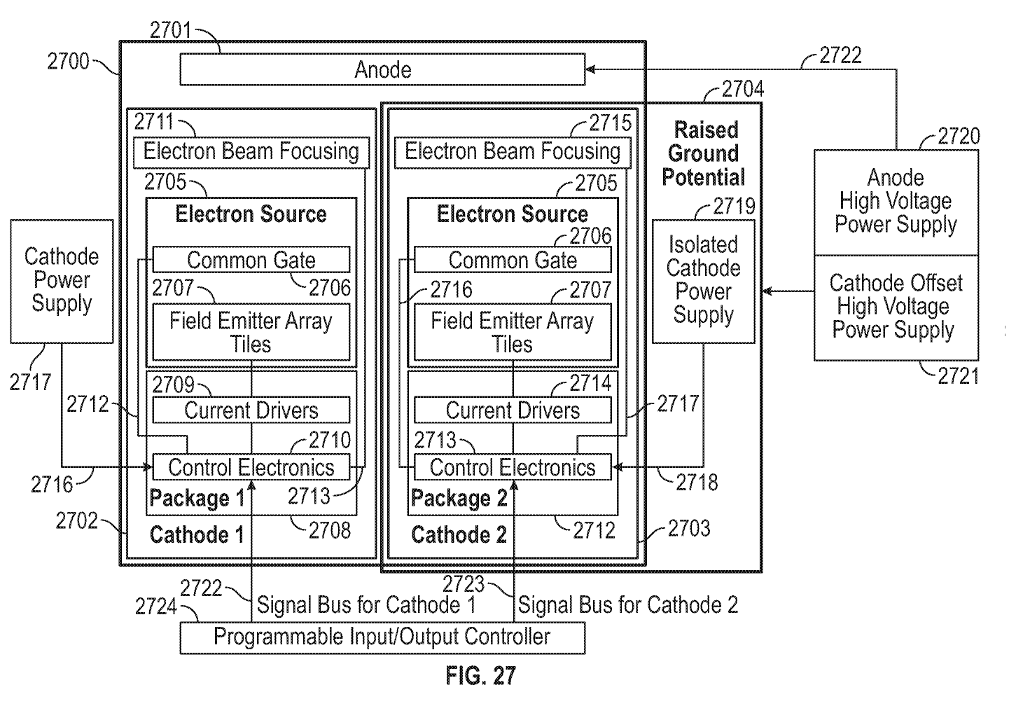

FIG. 27 illustrates an exemplary block diagram schematic of a system comprising an apparatus to control electron flow 2700 comprising a metal anode 2701 biased at a positive potential (i.e. a “positive-anode” configuration) and two dual-energy cathodes 2702 and 2703. Cathode 2702 is biased at a zero ground potential relative to the anode and cathode 2703 is isolated and its ground is biased at a positive ground potential between the zero ground and the anode potential. X-rays may be generated through bremsstrahlung after accelerating electrons from either cathode into the anode using a positive electric field applied from the anode to each cathode. By keeping one cathode 2702 at zero ground potential and raising the other cathode 2703 to a higher ground potential 2704 (i.e. reducing the voltage potential from anode to the electron sources in the raised potential cathode), the bremsstrahlung x-ray spectrum generated by the electron sources in each cathode held at different potentials will differ. The cathode with zero ground potential is the “high energy” cathode (i.e. the potential from anode to the zero ground potential is larger) and the cathode with raised ground potential is the “low energy” cathode (i.e. the potential from anode to the raised potential is lower than the other cathode). The anode is raised to its high potential 2722 with a high voltage power supply 2720. The raised potential cathode is raised to a high voltage between ground and the anode potential from a cathode high voltage power supply 2721. In some embodiments, the anode high voltage power supply 2720 and cathode high voltage power supply 2721 may be parts of the same power supply that can output two separate high voltage potentials (for example, using multiple taps from a single transformer). Although FIG. 27 depicts only one electron source 2705 in each cathode, in some embodiments there may be more than one electron source in each cathode, similar to the apparatus to control electron flow 1000 and cathode 1002 previously illustrated in FIG. 10. Although FIG. 27 illustrates two cathodes at two potentials, in some embodiments there may be more than two cathodes each biased at a different ground potential. Each cathode raised to a different potential may be used to generate a different x-ray energy spectrum. For embodiments using more than one raised cathode potential, the system may use additional high voltage power supply outputs as needed for each cathode potential. In some applications such as electron impact ionization, multiple energy cathodes may be used to tune the energy distribution of emitted electrons from each cathode by configuring the cathode potential relative to the anode.

Each cathode 2702 and 2703 may include one or more field emitter array electron sources 2705 (each including a common gate 2706 and field emitter array tiles 2707). Each cathode includes its own package substrate 2708 and 2712. The high energy cathode 2702 has its own package 2708 comprising the one or more electron sources 2705. The package 2708 may further comprise driver electronics 2709 for the field emitter array tiles, an electron beam focusing element 2711, control electronics 2710 for the drivers, control for the field emitter array electron source gate 2712, and control for the focusing element 2713. The low energy cathode 2703 has its own respective package 2712 comprising the one or more electron sources 2705. The low energy cathode package 2712 may further comprise driver electronics 2714 for the field emitter array tiles, an electron beam focusing element 2715, control electronics 2713 for the drivers, control for the field emitter array electron source gate 27 16, and control for the focusing element 2717. The high energy cathode 2702 is powered with voltage or current source 2716 from its own cathode power supply 2717, and the low energy cathode 2703 is powered with voltage or current source 2718 from its respective cathode power supply 2719. The raised potential cathode 2703 has a floating ground relative to the system ground. The electronics in the floating ground raised potential cathode 2703 (such as current drivers 2714, control electronics 2713, and cathode power supply 2719) are designed for a floating ground operation. In some embodiments, both cathodes and their electronics will be designed as the same floating ground electronics, and the system may simply connect the grounded, high energy cathode 2702 to system ground and raise the other cathode 2703 to its offset potential. In other embodiments, the electronics, drivers, and other peripheral circuitry in each cathode may be designed differently for its respective system ground or floating ground configuration.

In some embodiments, the electron beam focusing element in each cathode 2711 and 2715 may be configured differently (such as different geometries or bias potentials) to account for the different voltage potentials from anode to electron sources in each multi-energy cathode. For example, if the high energy cathode 2702 operates with 120-150 kV relative to the anode, its electron beam focusing element 2711 may be designed to be optimized for that potential range. Likewise, if the low energy cathode 2703 operates at 60-80 kV relative to the anode, its electron beam focusing element 2715 may be designed to be optimized for that potential range.

As similarly described for the system in FIG. 10-11, an external programmable controller 2724 (such as a microcontroller, FPGA, or other computing element) may be used to facilitate communication with each cathode 2702 and 2703 through respective signal buses 2722 and 2723 for each cathode. The external programmable controller 2724 may serve as an interface between one or more external computers or data acquisition systems and the one or more cathodes. For a cathode 2702 referenced to the system ground, the signal bus 2722 may be comprised of low voltage electrical or optical analog or digital signals. For the floating ground, raised potential cathode 2703, the signal bus 2723 may use optical signals or other electrically isolated signals for communication. For embodiments where both dual-energy cathode control electronics are designed as floating ground electronics, or for multi-energy systems including more than two different raised potential cathodes, it may simplify communication design to use optical communication interfaces for all cathodes to avoid designing for differing ground references in each signal bus.

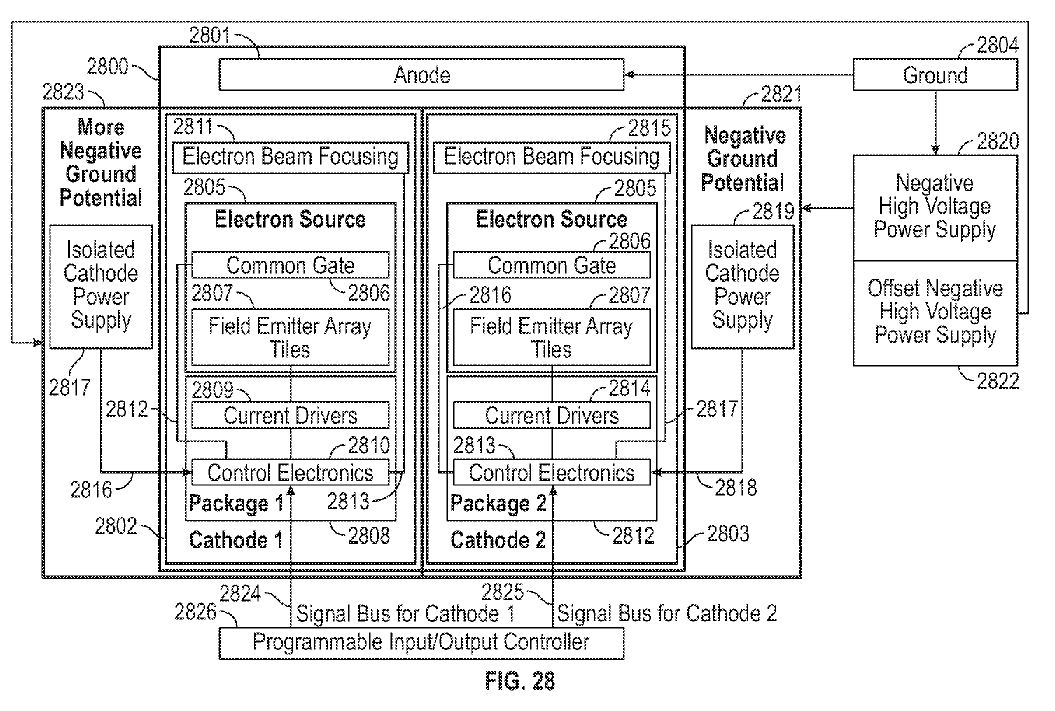

FIG. 28 illustrates an exemplary block diagram schematic of another embodiment of a system similar to FIG. 27 comprising an apparatus for electron flow control 2800, an anode 2801 held at a ground reference potential 2804, and two dual-energy cathodes 2802 and 2803 each held at a different negative potential relative to the anode. This embodiment in FIG. 28 is referred to as a “grounded-anode” dual-energy configuration (similar to the single-energy cathode grounded-anode system described in FIG. 11). In the illustration in FIG. 28, the cathode 2802 with the more negative potential magnitude 2823 is the “high energy” cathode and the other cathode 2803 with less negative potential magnitude 2821 is the “low energy” cathode. For example, cathode 2802 may be the high energy cathode held at negative potential -140 kV (relative to the anode) and cathode 2803 may be the low energy cathode held at negative potential -80 kV relative to the anode. The two negative cathode potentials may be generated from a negative high voltage power supply 2820 and 2822 for each cathode. Each cathode 2802 and 2803 may be coupled to the negative ground potential from a power supply through an isolation transformer. In some embodiments, the negative high voltage power supply 2820 and 2822 for each cathode may be from the same power supply that can output two separate potentials. Although FIG. 28 depicts only one electron source 2805 in each cathode, in some embodiments there may be more than one electron source in each cathode, similar to the apparatus to control electron flow 1100 and cathode 1102 previously illustrated in FIG. 11. Although FIG. 28 illustrates two cathodes at two negative potentials, in some embodiments there may be more than two cathodes each at a different negative potential to operate as a multi-energy cathode, where each negative potential may be generated from its own respective negative high voltage power supply output as needed. Similar to the positive-anode dual-energy configuration in FIG. 27, each cathode held at a different potential relative to the anode may generate a different bremsstrahlung x-ray spectrum from different electron energy potentials from each cathode to anode.

In the grounded-anode dual-energy cathode configuration in FIG. 28, each cathode has a floating ground isolated from the system ground (i.e. anode ground 2804). Each negative potential cathode 2802 and 2803 is similar to the floating ground, positive potential cathode 2704 previously described in FIG. 27. High energy cathode 2802 (i.e. at a more negative potential, such as -140 kV) has its own set of one or more electron sources 2805 (including common gate 2806 and field emitter array tiles 2807), on its own package 2808 which may further comprise control electronics 2810, field emitter array tile driver electronics 2809, focusing element 2811, gate control 2812, and focusing element control 2813, and its own current or voltage source 2816 from its own isolated cathode power supply 2817. Similarly, low energy cathode 2803 (i.e. at a less negative potential, such as -80 kV) has its own set of one or more electron sources 2805, package 2812 which may further comprise control electronics 2813, field emitter array tile driver electronics 2814, focusing element 2815, gate control 2816, and focusing element control 2817, and its current or voltage source 2818 from its own isolated cathode power supply 2819. In some embodiments, the electron beam focusing element in each cathode 2811 and 2815 may be designed differently to optimize for the different voltage potential from anode to electron sources in each dual-energy cathode (similar to previous FIG. 27).

An external programmable controller 2826 (such as a microcontroller, FPGA, or other computing elements) may be used to facilitate communication with each cathode 2802 and 2803 through respective signal buses 2824 and 2825 for each cathode (similar to the communication interface described in FIG. 27). Since each cathode is a floating ground with raised negative potential, the signal bus may use optical signals or other electrically isolated signals for communication across the differing ground potential references of the cathodes and the communication controller 2826 which is held at system ground.

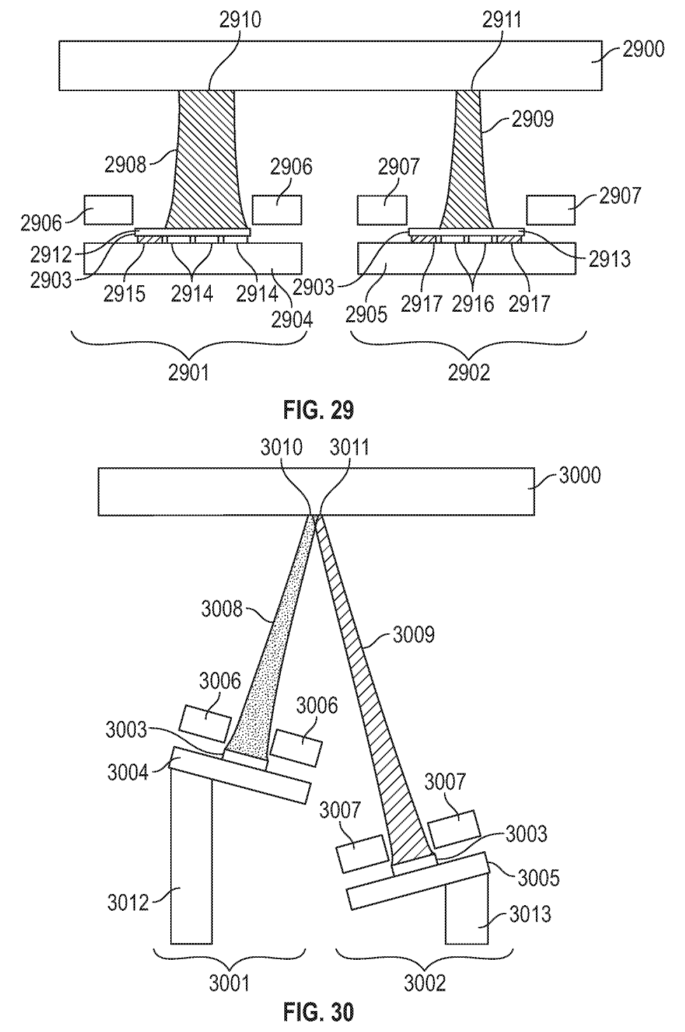

FIG. 29 illustrates an exemplary cross section schematic of an embodiment of an apparatus to control electron flow comprising an anode 2900 and two dual-energy cathodes 2901 and 2902. One cathode is configured to be the lower energy cathode while the other is configured to be the higher energy cathode. For illustrative purposes we designate cathode 2901 as the lower energy cathode and 2902 as the higher energy cathode, which does not preclude swapping the configuration. The lower energy cathode 2901 comprises its own field emitter array electron source 2903 on a package substrate 2904 with electron beam focusing element 2906. The higher energy cathode 2902 likewise comprises its own field emitter array electron source 2903 on a package substrate 2905 with electron beam focusing element 2907. Though only one anode is depicted and described in the following descriptions, in some embodiments the anode may comprise a module of multiple anode targets. Each of the multiple anodes may comprise of a different material. Each of the multiple anodes may be configured with different bias voltages. In such embodiments, the multiple cathodes may be configured to operate with one or more of the multiple anodes.

In an embodiment, the anode 2900 may be biased at a positive potential, and the low energy cathode 2901 may use a floating ground isolated from the other cathode 2902 ground, where the floating ground of cathode 2901 is configured to a positive potential to reduce the voltage potential between the anode 2900 and lower energy cathode 2901. Such configuration may correspond to the positive anode configuration apparatus previously described in FIG. 27. The higher energy cathode 2902 may generate an electron beam 2909 which may generate a focal spot 2911 on the anode with a higher max energy bremsstrahlung x-ray spectrum compared to the lower energy cathode 2901 electron beam 2908 and respective focal spot 2910 on the anode. Although both electron beams 2908 and 2909 are illustrated in FIG. 29, this is to show respective locations, and the cathodes are not required to operate simultaneously and each may be turned on or off as needed.

In another embodiment, the anode 2900 may be biased at a system ground potential, and both the lower energy cathode 2901 and higher energy cathode 2902 may each be configured with a floating ground biased to a different negative potential relative to the anode. Such configuration may correspond to the grounded-anode configuration apparatus previously described in FIG. 28. Such grounded anode configuration may operate similarly as a positive anode configuration previously described by configuring the potential from the anode to each cathode to be equivalent as a positive anode configuration.

Each individual cathode 2901 and 2902 in FIG. 29 may be treated independently as its own tiled field emitter array cathode. Hence, all previously described embodiments of a tiled field emitter array cathode, configurations, and operations in FIG. 12-26 may be applied to each separate tiled field emitter array cathode in an apparatus comprising multi-energy cathodes. While only one electron source is depicted in each cathode in FIG. 29, it can be understood that in some embodiments each cathode may include more than one electron source as in embodiments previously described in FIG. 12-26.

Another embodiment of a multi-modal focal spot 1601 on the anode 1600 comprises a focal spot comprising two disjoint, different sized regions 1602 and 1603 that are each configured to a different energy spectrum. This focal spot may be described as a dual-energy multi-modal focal spot. For example, focal spot region 1602 may be generated from a lower energy cathode and generate a lower energy bremsstrahlung x-ray spectrum and focal spot region 1603 may be generated from a higher energy cathode and generate a higher energy bremsstrahlung x-ray spectrum, or vice versa. In other embodiments, the focal spot may be comprised of more than two disjoint, different sized regions each with a different energy spectrum. These may be described as multi-energy multi-modal focal spots.

In an embodiment, FIG. 29 illustrates an apparatus to control electron flow configured with two dual-energy tiled field emitter array cathodes 2901 and 2902 configured to generate a dual-energy multi-modal focal spot pattern on the anode 2900. For illustrative purposes, we designate cathode 2901 as the lower energy cathode and cathode 2902 as the higher energy cathode. The lower energy cathode 2901 includes one or more of its own tiled field emitter array electron sources 2903 on a package substrate 2904 configured to a lower potential from anode to cathode, and may further comprise an electron beam focusing element 2906. The higher energy cathode 2902 similarly includes one or more of its own field emitter array electron sources 2903 on a package substrate 2905 configured to a higher potential from anode to cathode, and may further comprise an electron beam focusing element 2907. In an embodiment, within each field emitter array electron source 2903 in each cathode, groups of tiles may be turned on and off to generate the different multi-energy multi-modal focal spot patterns and sizes. For example, the lower energy cathode 2901 electron source may comprise a common gate 2912 and emitter tiles configured with a larger group of tiles 2914 turned on and remaining tiles 2915 turned off to generate a larger electron beam 2908 and respective larger focal spot region on the anode 2910 with a lower energy spectrum. The other electron source 2903 in the high energy cathode 2902 may comprise a common gate 2913 and emitter tiles configured with a smaller group of tiles 2916 turned on and remaining tiles 2917 turned off to generate a smaller electron beam 2909 and respective smaller focal spot region 2911 on the anode at a higher energy spectrum. In another embodiment, this configuration could be reversed so that the lower energy cathode 2901 generates a smaller focal spot region while the higher energy cathode 2902 generates a larger focal spot region. The energy spectrum of each focal spot region may be adjusted by changing the potential on either cathode as needed. In other embodiments, different subsets of tiles in each field emitter array may be turned on and off to generate other multi-modal focal spot patterns on the anode. Additionally, in other embodiments there may be more than one electron source in each cathode to generate other multi-modal focal spot patterns with more than two spots on the anode. In other embodiments with more than two dual-energy cathodes, similar arrangements can be made to generate multi-energy multi-modal focal spots on the anode by configuring the potential and emission pattern from each cathode. Although not illustrated, within each group of field emitter array tiles that is turned on, the field emitter array tile output current profile may be modulated similar to FIG. 15 to generate arbitrary focal spot intensity profiles within each multi-modal focal spot region on the anode.

FIG. 30 illustrates an embodiment of an apparatus to control electron flow comprising an anode 3000 and two dual-energy cathodes 3001 and 3002 configured so that the designated lower energy cathode 3001 is raised in position towards the anode 3000 relative to the designated higher energy cathode 3002. The lower energy cathode 3001 includes one or more field emitter array electron sources 3003 on a package substrate 3004, which may further comprise an electron beam focusing element 3006. The lower energy cathode generates a lower energy electron beam 3008 and respective focal spot 3010 on the anode. The higher energy cathode 3002 likewise includes one or more field emitter array electron sources 3003 on a separate package substrate 3005, which may further comprise an electron beam focusing element 3007. The higher energy cathode generates a higher energy electron beam 3009 and respective focal spot 3011 on the anode. Placing the lower energy cathode 3001 closer to the anode than the higher energy cathode 3002 may reduce electric field distortions caused by the different potential from each cathode, which may affect the steering of each cathode’s electron beam. For example, the higher energy cathode 3002 may be configured at about -140 kV and the lower energy cathode 3001 may be configured at -80 kV. In an arrangement like FIG. 29 where each cathode 2901 and 2902 is adjacent to one another, the 60 kV difference between cathodes may impact the trajectory of the other cathode’s electron beam and may also require larger isolation distance between cathodes to avoid electrical breakdown. By raising the lower energy cathode 3001 to a position towards the anode as in FIG. 30, for example to a location in space where the potential is about -80 kV, this may reduce electric field distortions and also reduce isolation required between the low and high energy cathode to avoid electrical breakdown. The location towards the anode to place the lower energy cathode may be decided by considering the energy range for each cathode and placing the cathodes along the potential field for those energy ranges. In some embodiments, the lower energy cathode may be raised in position using a structural component 3012 that is part of the package substrate or may be part of the apparatus structure that the cathode package is attached to. For example, in the embodiment in FIG. 30, lower energy cathode 3001 (for example, at -80 kV) is attached to a cathode stem 3012 that raises it closer towards the anode, while the higher energy cathode (for example, at -140 kV) may be attached to a shorter stem 3013. The cathode stems may include wiring connections for the cathode elements such as the electron sources, control electronics, and focusing element.

In an embodiment, an apparatus to control electron flow illustrated in FIG. 30 may be configured with dual-energy cathodes 3001 and 3002 oriented so that each cathode generates its respective focal spot 3010 and 3011 at about the same location on the anode 3000. The cathode orientation may assist in steering the respective cathode electron beams 3008 and 3009 towards a designated target location on the anode. This may benefit x-ray applications where the different energy x-ray beams are desired to project from about the same focal spot location on the anode. In other embodiments, the focal spot locations 3010 and 3011 may be configured to be slightly offset similar to FIG. 20. In other embodiments, the focal spot locations may be adjusted to generate multi-energy multi-modal focal spot patterns like FIG. 16, for example by orienting each beam to reach the desired spot 1602 or 1603 on the anode. Each cathode may comprise a field emitter array electron source 3003 where the emitter tiles may be turned on and off to fine tune the focal spot shape and location generated on the anode. The cathode may further comprise electron beam focusing elements 3006 and 3007 which may be configured to assist in steering the electron beam to the desired focal spot locations 3010 and 3011. In some embodiments, the orientation of the electron sources may be configured using the geometry of the cathode package, similar to FIG. 22. In other embodiments, the orientation may be configured using a cathode package structural attachment element like 3012 and 3013. Each cathode may be configured with a different orientation designed for the cathode’s different potential relative to the anode. In embodiments where each dual-energy cathode is placed at a different distance to the anode, the orientation may also be designed with consideration for the different distances to the anode.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”
It should be understood that the foregoing description is only illustrative of the present disclosure.
Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

1. An apparatus for controlling electron flow comprising:
a cathode comprising:
a package substrate;
at least one electron source mounted on the package substrate, the electron source comprising a plurality of field emitter array tiles and a common gate electrode disposed above the field emitter array tiles, the common gate electrode having openings aligned with emitter tips in the field emitter array tiles to allow passage of emitted electrons; and
a focusing element disposed above the at least one electron source, the focusing element comprising a conductive structure with through-apertures aligned with each electron source to shape an electron beam emitted by the field emitter array tiles; and
one or more anodes comprising a metal target distant from the focusing element,
wherein the common gate electrode of each electron source is held at a fixed bias voltage, and the field emitter array tiles of each electron source are electrically pulsed to generate one or more electron beams directed through the focusing element towards an anode.

2. The apparatus of claim 1, further comprising control electronics configured to use external optical signals to programmatically turn individual field emitter array tiles on and off.

3. The apparatus of claim 1, wherein the electron sources are configured to output different focal spot shapes on an anode by selectively turning field emitter array tiles on and off.

4. The apparatus of claim 1, wherein the field emitter array tiles in an electron source are configured to output different currents to generate an arbitrary focal spot intensity pattern on an anode.

5. The apparatus of claim 1, wherein an electron beam focusing element opening above an electron source contains multiple disjoint openings with different sized areas.

6. The apparatus of claim 1, wherein the electron beam focusing element openings above the electron sources do not all have the same geometry.

7. The apparatus of claim 1, wherein two or more adjacent electron sources have different geometries.

8. The apparatus of claim 1, wherein different sized, disjoint groups of field emitter array tiles are turned on at the same time within the same electron source to generate a focal spot pattern with different sized, disjoint focal spot regions.

9. The apparatus of claim 1, wherein two or more electron sources are turned on simultaneously wherein different subsets of field emitter array tiles are turned on within each electron source to generate a focal spot pattern with different sized, disjoint focal spot regions.

10. The apparatus of claim 1, wherein two or more electron sources are configured with an electron beam focusing element shaped to steer the electron beam from each electron source to partially or fully overlap their focal spots on an anode.

11. The apparatus of claim 1, wherein two or more electron sources are oriented on the package substrate to steer their electron beams to partially or fully overlap their focal spots on an anode.

12. The apparatus of claim 1, wherein two or more electron sources are oriented such that the first electron source is configured to generate an x-ray fan beam, and the other electron sources are aligned so that one edge of their x-ray fan beam is aligned with an edge of the x-ray fan beam of the first electron source.

13. The apparatus of claim 1, wherein an anode is angled and two or more electron sources in the cathode are offset along their in-plane positions so that their focal spots on an angled anode are offset along the anode angle.

14. The apparatus of claim 1, wherein more than one anode are configured at different bias voltages.

15. An apparatus for controlling electron flow comprising:
two or more cathodes comprising:
a package substrate;
at least one electron source mounted on the package substrate, the electron source comprising a plurality of field emitter array tiles and a common gate electrode disposed above the field emitter array tiles, the common gate electrode having openings aligned with emitter tips in the field emitter array tiles to allow passage of emitted electrons;
a focusing element disposed above the at least one electron source, the focusing element comprising a conductive structure with through-apertures aligned with each electron source to shape an electron beam emitted by the field emitter array tiles; and
one or more anodes comprising a metal target distant from the focusing element,
wherein the common gate electrode of each electron source is held at a fixed bias voltage, and the field emitter array tiles of each electron source are electrically pulsed to generate one or more electron beams directed through the focusing element towards an anode, and wherein each cathode of the two or more cathodes is configured with a different voltage ground potential relative to the one or more anodes.

16. The apparatus of claim 15, wherein one or more electron sources from each of the two or more cathodes configured at different potentials are turned on and off sequentially in time.

17. The apparatus of claim 15, wherein the focal spot generated from each cathode of the two or more cathodes is unique.

18. The apparatus of claim 15, wherein one or more electron sources from each of the two or more cathodes configured at different potentials are operated simultaneously to generate disjoint, different sized focal spot regions on the anode with different energy spectrums for each focal spot region.

19. The apparatus of claim 15, wherein two or more electron sources in the two or more cathodes configured at different potentials are operated simultaneously with overlapping focal spots on an anode.

20. The apparatus of claim 15, wherein two or more cathodes at different potentials are physically oriented so their generated electron beam focal spots appear at about the same location on an anode.
